(19) United States
(12) Patent Application Publication
(10) Pub. No.: US 2025/0326238 A1
(43) Pub. Date: Oct. 23, 2025

(54) DISPLAY METHOD

(71) Applicant: MIMAKI ENGINEERING CO., LTD., Nagano (JP)

(72) Inventors: Yukinari Kobayashi, Nagano (JP); Yu Kawabata, Nagano (JP)

(73) Assignee: MIMAKI ENGINEERING CO., LTD., Nagano (JP)

(21) Appl. No.: 18/869,824

(22) PCT Filed: May 25, 2023
(86) PCT No.: PCT/JP2023/019422

§ 371 Date: Nov. 26, 2024

(30) Foreign Application Priority Data
May 27, 2022 (JP) 2022-087167
May 27, 2022 (JP) 2022-087168
May 27, 2022 (JP) 2022-087169

(51) Int. Cl. B41J 29/38; B41J 2/175; G06F 3/12

(52) U.S. Cl. CPC B41J 29/38; B41J 2/17566; G06F 3/1219; G06F 3/1234; G06F 3/1285; B41J 2002/17589

(57) ABSTRACT

The present invention manages a status of a printer. A display method for causing of an electronic apparatus to display information in a printing system that includes a printer, a management server, and the electronic apparatus (a PC and an electronic device), the display method including: an information transmission step of transmitting printer information from the management server to the electronic apparatus; and a display step of causing the electronic apparatus to display information based on the printer information, the management server manages, as the printer information, operation information, ink usage information, and printed area information, and in the display step, aggregation of operation status, aggregation of an amount of ink used, and aggregation of the printed area are displayed on one screen based on the operation information, the ink usage information, and the printed area information.

### TECHNICAL FIELD

This present invention relates to a display method, an electronic apparatus, a program, and a management system.

### BACKGROUND ART

Conventionally, printers such as inkjet printers are widely used. Further, as a method of controlling operation of a printer, a method using a PC that performs raster image processor (RIP) processing is widely used (see, for example, Patent Literature 1).

### CITATION LIST

### Patent Literature

Patent Literature 1: Japanese Unexamined Patent Publication No. 2005-138583

### SUMMARY OF INVENTION

### Technical Problems

In a case where the operation of a printer is controlled by using a PC or the like that performs RIP processing, a status of the printer can be managed by, for example, executing a program (application software) that manages the status of the printer on that PC. However, depending on uses of the printer or the like, it may be desirable to manage the status of the printer by a more appropriate method. Therefore, an object of the present invention is to provide a display method, an electronic apparatus, a program, and a management system that can solve the above problem.

### Solutions to Problems

The inventor of the present application has conducted extensive research on how to manage a printer. Then, instead of simply managing the status of the printer with only a PC or the like for RIP processing, the inventor considered collecting information indicating the status of the printer in a server and acquiring the information from the server to check the status of the printer. With this configuration, the status of the printer can be checked at various places not limited to the place such as where the printer is installed. Further, as a result, a person other than a user (an operator) who operates the printer can check the status of the printer as necessary.

Further, in this case, in order to easily and appropriately check the status of the printer, it may be desirable to display necessary information of an electronic apparatus or the like that displays information, collectively on one screen. Further, regarding this point, the inventor of the present application has found, through intensive research, that it is particularly preferable to display aggregation of operation status of the printer, aggregation of an amount of ink used, and aggregation of the printed area on one screen. By displaying these pieces of information on one screen, it is possible to easily and appropriately check whether or not the printer is stably operating. Further, for example, it is also possible to collectively grasp useful information in a case of considering running cost of the printer and the like. Furthermore, for example, in a case where a problem occurs in the status of the printer, it is also possible to collectively grasp useful information for grasping the problem.

Further, the inventor of the present application has found features necessary for obtaining such effects through further intensive research, and has reached the present invention. In order to solve the above problem, the present invention provides a display method for causing an electronic apparatus to display information in a printing system that includes a printer, a management server that manages printer information that is information indicating a status of the printer, and the electronic apparatus that performs display based on the printer information acquired from the management server, the display method including: an information transmission step of transmitting the printer information associated with the printer from the management server to the electronic apparatus; and a display step of causing the electronic apparatus to display information based on the printer information transmitted from the management server to the electronic apparatus in the information transmission step, in which the management server manages, as the printer information, at least operation information indicating an operation status of the printer, ink usage information indicating an amount of ink used in the printer, and printed area information indicating printed area, which is area where printing has been performed in the printer, in association with the printer, and in the information transmission step, at least the operation information, the ink usage information, and the printed area information are transmitted from the management server to the electronic apparatus, and in the display step, based on the operation information, the ink usage information, and the printed area information, aggregation of operation status of the printer, aggregation of the amount of ink used in the printer, and aggregation of the printed area where printing has been performed in the printer are displayed on one screen.

With this configuration, the status of the printer can be appropriately grasped by performing display based on the printer information acquired from the management server with the electronic apparatus. Further, in this case, the status of the printer can be easily and appropriately grasped by causing the electronic apparatus to display the aggregation of operation status of the printer, the aggregation of the amount of ink used, and the aggregation of the printed area on one screen. Therefore, with this configuration, the status of the printer can be managed more appropriately.

Further, in this case, it is conceivable to receive designation of an aggregation period (a display period) from the user who operates the electronic apparatus for the aggregation of operation status of the printer, the aggregation of the amount of ink used, and the aggregation of the printed area. Further, in this case, it is conceivable to allow the user to select whether to collectively set or individually set the period in a user interface (UI) in the electronic apparatus, and then cause the electronic apparatus to display the aggregation in the designated period. In this case, the display method further includes an aggregation period setting step of setting an aggregation period corresponding to the information to be displayed on the electronic apparatus in the display step. Then, a period during which the aggregation of operation status is performed, a period during which the aggregation of the amount of ink used is performed, and a period during which the aggregation of the printed area is performed are collectively or individually set according to the user's selection in the aggregation period setting step. Further, in the display step, the aggregation of operation status, the aggregation of the amount of ink used, and the aggregation of the printed area are displayed on the electronic apparatus according to the period set in the aggregation period setting step. With this configuration, the aggregation period can be appropriately changed according to the user's desire. Further, by collectively or individually setting a display manner, it is possible to more appropriately check the status of the printer, perform various examinations, and the like.

Further, in this configuration, in the display step, as the aggregation of operation status, for example, aggregation of a standby period indicating a period during which the printer has been on standby, a printing period indicating a period during which printing has been executed by the printer, an error stop period indicating a period during which the printer has been stopped due to an error, and an offline period indicating a period during which information of the printer could not be acquired is displayed on the electronic apparatus. With this configuration, the operation status of the printer can be appropriately grasped.

In the display step, as the aggregation of operation status, for example, a bar graph or a pie chart indicating a time period during which the printer was in each of a plurality of types of status of the printer is displayed on the electronic apparatus. With this configuration, it is possible to cause the electronic apparatus to perform display that facilitates grasping of the operation status. Further, as a result, the operation status of the printer can be more appropriately grasped. In this case, it can be considered that operational status of the printer is visualized by causing the electronic apparatus to display the aggregation of operation status corresponding to the printer in the display step. Further, by visualizing the operational status of the printer, it is possible to make improvements that increase productivity of the printer, leading to efficient production.

Further, in the display step, for example, a bar graph or a line graph is displayed on the electronic apparatus as the aggregation of the amount of ink used. With this configuration, the aggregation of the amount of ink used can be appropriately grasped. Further, in this configuration, the printer may perform printing using a plurality of colors of ink. In this case, in the display step, for the aggregation of the amount of ink used, either or both of the aggregation of the amount of ink used for each color and the aggregation of the amount of ink used in a total amount of ink used obtained by aggregating all the colors of the plurality of colors of ink are displayed on the electronic apparatus according to the user's selection. With this configuration, in a case where a plurality of colors of ink are used, the aggregation of the amount of ink used can be more appropriately grasped. Further, by displaying the aggregation of the amount of ink used in the total amount of ink used obtained by aggregating all the colors, the cost of all the colors can be easily calculated in a case such as where the cost of printing is estimated.

Further, in the display step, for example, a bar graph or a line graph is displayed on the electronic apparatus as the aggregation of the printed area. With this configuration, the aggregation of the printed area can be appropriately grasped. Further, in the display step, the aggregation of the printed area may be divided and displayed for each category in a plurality of preset categories. With this configuration, more various information regarding the aggregation of the printed area can be displayed. Further, in this case, as the display for each category, it is conceivable to perform display for each medium used for printing, display for each print data, and the like.

Further, in the display step, for example, a plurality of the aggregation of operation status of the printer, the aggregation of the amount of ink used, and the aggregation of the printed area may be displayed in one graph. With this configuration, a correlation and the like between a plurality of aggregation targets can be easily and appropriately grasped. In this case, it is conceivable to display the aggregation of operation status and the aggregation of the amount of ink used in one graph to confirm the correlation between them.

Further, in this configuration, it is also conceivable to display various numerical values and the like according to the user's operation on the electronic apparatus. For example, in a case where the user places a cursor on the graph, it is conceivable to cause the electronic apparatus to display a numerical value corresponding to the position. Further, in this case, in the display step, for example, a cursor that moves according to the user's operation and a graph indicating at least one of the aggregation of operation status of the printer, the aggregation of the amount of ink used, and the aggregation of the printed area are displayed. Then, in a case where the cursor is positioned on the graph by the user's operation, a numerical value corresponding to the position of the cursor in the graph is displayed. With this configuration, the electronic apparatus can display more detailed information to the user. Further, in this case, it is conceivable to cause the electronic apparatus to display a value for each time, a value for each day, an accumulated value, a value on a vertical axis, a value on a horizontal axis, or the like as a numerical value.

Further, in this configuration, it is also conceivable to display a maximum value and a minimum value of the graph in a conspicuous manner. In this case, in the display step, for example, it is conceivable to display a graph indicating at least one of the aggregation of operation status of the printer, the aggregation of the amount of ink used, and the aggregation of the printed area, and to make the display manner of the maximum value and the minimum value of the graph different from other values. With this configuration, it is possible to easily grasp the position of the maximum value or the minimum value in the graph. Further, in this case, it is conceivable to change the display of color, shape, or the like for the maximum value or the minimum value during the period.

Further, it is conceivable to manage the printer in association with the user of the printer, for example. Further, the inventor of the present application further considered managing printers by dividing them into groups. With this configuration, even in a case where a plurality of printers are associated with one user or one organization as a user, the printer can be managed more easily and appropriately. Further, in this case, it is conceivable to cause an electronic apparatus that performs display for checking the status of the printer to perform display by, for example, a method selected according to the user's instruction from among a plurality of types of display manners. With this configuration, in a case where the information on the plurality of printers is managed by the server, the information required by the user can be appropriately displayed on the electronic apparatus. Further, as a result, the status of the printer can be managed more appropriately.

Further, the inventor of the present application has found features necessary for obtaining such effects through further intensive research, and has reached the present invention. In order to solve the above problems, the present invention provides a display method for causing an electronic apparatus to display information in a printing system that includes a printer, a management server that manages printer information that is information on the printer, and the electronic apparatus that performs display based on the printer information acquired from the management server, the display method including: an information transmission step of transmitting the printer information associated with the printer from the management server to the electronic apparatus; and a display step of causing the electronic apparatus to display information based on the printer information transmitted from the management server to the electronic apparatus in the information transmission step, in which the management server manages the printer in association with a user of the printer, and manages printers by dividing them into groups including one or more printers, and in a case where the management server manages a plurality of the printers associated with the user, in the display step, with respect to a display manner based on the printer information, from among a plurality of types of display manners that include display for each printer in which information on the individual printers is displayed; group display in which information on the printers included in any of the groups is displayed; and full display in which information on all the printers associated with the user is displayed, according to the user's instruction, one of batch display in which the display for each printer, the group display, and the full display are performed on one screen, and individual display in which one of the display for each printer, the group display, and the full display is selected and displayed, is selected, and information based on the printer information is displayed on the electronic apparatus.

With this configuration, in a case where the management server manages a plurality of printers associated with the user, the display manner based on the printer information can be selected from a plurality of methods. Further, in this case, according to the user's instruction, one of the batch display in which the display for each printer, the group display, and the full display are performed on one screen, and the individual display in which one of the display for each printer, the group display, and the full display is selected and displayed, is selected, and the information required by the user can be appropriately displayed on the electronic apparatus by displaying the information based on the printer information on the electronic apparatus. Further, as a result, the status of the printer can be appropriately grasped.

Further, in a case where the management server manages a plurality of printers associated with the user, in the display step, aggregation display in which information on the plurality of printers associated with the user is aggregated and displayed and the display for each printer in which information on individual printers is displayed may be displayed on the electronic apparatus on one screen. In this case, in the aggregation display, for example, one of group aggregation display in which information on the printers included in the same group is aggregated, and full aggregation display in which information on all the printers associated with the user is aggregated is displayed on the electronic apparatus. Even with this configuration, information required by the user can be appropriately displayed on the electronic apparatus. Further, as a result, the status of the printer can be managed more appropriately.

Further, in this configuration, printers associated with the user are divided into groups by, for example, user manual setting by the user's operation or automatic setting based on a preset rule. With this configuration, grouping of the printers can be appropriately performed. Further, with respect to grouping, it is also conceivable to group the printers associated with the user, for example, by each production line that produces a product using the printer or by each product. With this configuration, grouping according to how to use the printer and the like can be appropriately performed. Further, as a result, it is possible to facilitate aggregation of production output and costs for production of the product performed using the printer. Further, in this configuration, in the display step, for example, it is conceivable to cause the electronic apparatus to display at least one of a printer outline indicating an outline of the printer, printer status indicating the status of the printer, an operation result of the printer, and a maintenance history for the printer based on the printer information. With this configuration, the status of the printer can be appropriately checked based on the printer information.

Further, in a case of managing the status of the printer, it is conceivable to manage various types of information regarding the printer. Then, in this case, necessary information may change depending on work to be performed, the status of the printer, and the like. Therefore, in order to check the status of the printer by acquiring information from the server, it is desirable to appropriately display information that the user wants to see in an electronic apparatus or the like that performs display based on the information. On the other hand, the inventor of the present application considered a display method for displaying information on an electronic apparatus that acquires information from a server, in which the printer status, the operation result, and the maintenance history are switched according to the user's operation and displayed on the electronic apparatus. Further, it was found that information necessary for managing the status of the printer is presented to the user and the status of the printer can be efficiently and appropriately managed by switching these items and displaying them on the electronic apparatus.

Further, the inventor of the present application has found features necessary for obtaining such effects through further intensive research, and has reached the present invention. In order to solve the above problems, the present invention provides a display method for causing an electronic apparatus to display information in a printing system that includes a printer, a management server that manages printer information that is information on the printer, and the electronic apparatus that performs display based on the printer information acquired from the management server, the display method including: an information transmission step of transmitting the printer information associated with the printer from the management server to the electronic apparatus; and a display step of causing the electronic apparatus to display information based on the printer information transmitted from the management server to the electronic apparatus in the information transmission step, in which the management server manages, as the printer information, at least printer status indicating a status of the printer, an operation result of the printer, a print history of the printer, and a maintenance history for the printer in association with the printer, and in the information transmission step, at least the printer status, the operation result, the print history, and the maintenance history are transmitted from the management server to the electronic apparatus, and in the display step, the printer status, the operation result, the print history, and the maintenance history are switched and displayed on the electronic apparatus according to a user's operation.

With this configuration, information necessary for managing the status of the printer can be appropriately presented to the user. Further, as a result, the status of the printer can be managed efficiently and appropriately. In this configuration, the printer status is, for example, information indicating at least an ink set name indicating an ink set to be used in the printer, ink information related to ink to be used in the printer, a drawing range indicating a range in which printing can be executed by the printer, a print length indicating a length of an output printed by the printer, and the amount of waste ink generated in the printer. With this configuration, the printer status can be appropriately displayed. Further, the operation result is, for example, information indicating at least aggregation of operation information indicating the operation status of the printer, aggregation of the amount of ink used in the printer, and aggregation of the printed area, which is area where printing has been performed in the printer. With this configuration, the operation result can be appropriately displayed. Further, the print history is, for example, information indicating at least a history related to the number of times of printing and a history of a print job executed in the past. With this configuration, the print history can be appropriately displayed. Further, the maintenance history is information indicating at least a date when a predetermined maintenance has been most recently performed on the printer. With this configuration, the maintenance history can be appropriately displayed.

Further, in association with the display of the maintenance history, in the display step, for example, it is conceivable to cause the electronic apparatus to perform at least one of a warning for prompting execution of the maintenance and a warning for prompting replacement of consumables used in the printer. With this configuration, a warning related to maintenance can be appropriately issued to the user. In this case, the consumables used in the printer are, for example, replacement parts that are worn due to use of the printer. Further, in this case, the electronic apparatus may be caused to notify of inventory information of the consumables in the display step. With this configuration, it is possible to present information useful for considering replenishment of consumables to the user. Further, in the display step, the user may be prompted to order the consumables based on inventory status of the consumables. With this configuration, it is possible to allow the user to more appropriately recognize necessity of replenishing the consumables. Further, in the display step, for example, whether or not a preset recommended maintenance has been performed may be displayed on the electronic apparatus. With this configuration, it is possible to appropriately notify the user whether or not necessary maintenance has been performed. Further, in this case, it is possible to allow the user to recognize importance of maintenance by indicating a guide to the necessary maintenance. Further, as a result, it is possible to prevent a trouble from occurring in the printer in advance.

Further, in this configuration, the printing system includes a user device and a maintenance personnel device as the electronic apparatus. In this case, the user device can be considered as an electronic apparatus or the like that displays information to a user who uses the printer. The maintenance personnel device can be considered as an electronic apparatus or the like that displays information to a maintenance personnel who provides maintenance service to the printer. Further, in this case, in the display step, at least the maintenance personnel device is caused to display whether or not the recommended maintenance has been performed. With this configuration, the maintenance personnel can be appropriately notified of the status of the printer useful for maintenance. Further, in this case, for example, when a problem occurs in the printer, it is possible to easily and appropriately take a measure based on whether or not the recommended maintenance has been performed. Further, it is also possible for the maintenance personnel to quickly respond to a trouble by grasping the maintenance history. Further, in the display step, it is preferable to also cause the user device to display whether or not the recommended maintenance has been performed. With this configuration, it is possible to appropriately indicate a guide to the necessary maintenance to the user who uses the printer.

Further, in this configuration, the management server accepts sign-in of the user by user authentication via the electronic apparatus. Further, in a case where a preset time period has elapsed after the sign-in of the user, it is conceivable to cause the electronic apparatus to warn the user. With this configuration, it is possible to appropriately prevent a sign-in status for a long time from continuing without the user noticing. Further, the management server manages the printer in association with the user of the printer, for example. Furthermore, the management server manages the printers by, for example, dividing them into groups including one or more printers.

Further, in a case where the management server manages a plurality of printers associated with the user, in the display step, with respect to the display manner based on the printer information, for example, one of the batch display and the individual display may be selected according to the user's instruction from among a plurality of types of display manners that include display for each printer in which information on individual printers is displayed; group display in which information on the printers included in any of the groups is displayed; and full display in which information on all the printers associated with the user is displayed, and the information based on the printer information may be displayed on the electronic apparatus. In this case, the batch display can be considered as display in which the display for each printer, the group display, and the full display are performed on one screen. Further, the individual display can be considered as display in which one of the display for each printer, the group display, and the full display is selected and performed.

With this configuration, in a case where the management server manages a plurality of printers associated with the user, the display manner based on the printer information can be selected from a plurality of methods. Further, in this case, by selecting one of the batch display and the individual display according to the user's instruction and causing the electronic apparatus to display the information based on the printer information, the information required by the user can be appropriately displayed on the electronic apparatus. Further, as a result, the status of the printer can be appropriately grasped.

Further, in a case where the management server manages a plurality of printers associated with the user, in the display step, aggregation display in which information on the plurality of printers associated with the user is aggregated and displayed and the display for each printer in which information on individual printers is displayed may be displayed on the electronic apparatus on one screen. In this case, in the aggregation display, it is conceivable to cause the electronic apparatus to display one of the group aggregation display in which information on the printers included in the same group is aggregated, and the full aggregation display in which information on all the printers associated with the user is aggregated. Even with this configuration, information required by the user can be appropriately displayed on the electronic apparatus. Further, as a result, the status of the printer can be appropriately grasped.

Further, as the configuration of the present invention, configurations of an electronic apparatus, a program, a management system, and the like having the same features as those described above can be considered. In this case, the program can be considered as a program or the like executed in at least one of the management server or the electronic apparatus in order to cause the electronic apparatus to display information. The management system can be considered as a system that manages a printer in the printing system. Even with these configurations, the same effects as those described above can be obtained.

### Effect of the Invention

According to the present invention, the status of the printer can be managed more appropriately.

### BRIEF DESCRIPTION OF THE DRAWINGS

FIG. 1 is a diagram illustrating an example of a configuration of a printing system 10 according to one embodiment of the present invention.

FIG. 2 is a diagram describing specific configurations of a user base 14 and an external management unit 16. In FIG. 2, (a) illustrates an example of the configuration of the user base 14. In FIG. 2, (b) illustrates an example of the configuration of the external management unit 16.

FIG. 3 is a diagram describing how printer information is managed by a management server 12.

FIG. 4 is a view illustrating an example of a display screen in a case where a list of printers 114 is displayed on a PC 112 or the like.

FIG. 5 is a view illustrating an example of a display screen to be displayed on the PC 112 or the like.

FIG. 6 is a view illustrating an example of information to be displayed for a plurality of printers 114.

FIG. 7 is a view illustrating an example of how to change an aggregation period.

FIG. 8 is a display screen showing more detailed information for a part of the information on the printer 114.

FIG. 9 is a view illustrating an example of a display screen related to printer status.

FIG. 10 is a view illustrating an example of a display screen related to an operation result of the printer 114.

FIG. 11 is a view illustrating an example of a display screen related to a print history.

FIG. 12 is a view illustrating an example of a display screen related to a print history.

FIG. 13 is a view illustrating an example of a display screen related to a maintenance history.

### DESCRIPTION OF EMBODIMENTS

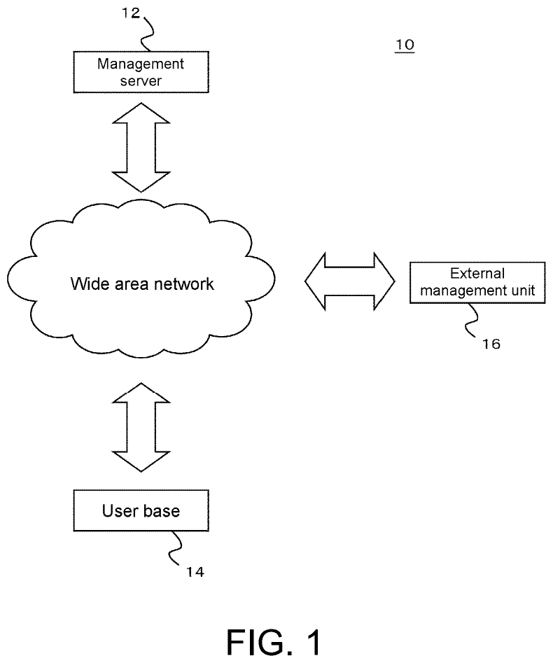

An embodiment according to the present invention will be described below with reference to the drawings. FIG. 1 illustrates an example of a configuration of a printing system 10 according to one embodiment of the present invention. The printing system 10 of the present example is a system that performs printing using a printer, and includes a management server 12, a user base 14, and an external management unit 16. Except for points to be described below, the printing system 10 may have the same or similar features as known printing systems.

The management server 12 is a server that manages printer information, which is information on a printer used in the printing system 10. The management server 12 of the present example is a cloud server that communicates with other configurations via a wide area network such as the Internet, and manages the printer information according to a program executed on the cloud. Further, the management server 12 acquires printer information regarding the printer installed at the user base 14 by communicating with an electronic apparatus installed at the user base 14 via the wide area network. Further, the printer information is supplied to the electronic apparatuses by communicating with the electronic apparatuses provided in the user base 14 and the external management unit 16 via the wide area network. Further, as a result, the management server 12 causes the electronic apparatuses to perform display based on the printer information. The operation and the like of causing the electronic apparatuses to perform display based on the printer information will be described in more detail later.

Note that, it is conceivable to use a server or the like provided by a cloud server operator as the management server 12. In this case, a computer that functions as the management server 12 can be considered to be managed by a person different from administrators of the user base 14 and the external management unit 16. Further, in this case, it is conceivable to cause the server or the like provided by the cloud server operator to function as the management server 12 by controlling the server or the like from the external management unit 16. Further, in a modified example of the configuration of the printing system 10, it is also conceivable to use a computer managed by the same administrator as the administrator of the user base 14 or the external management unit 16 as the management server 12. In this case, the management server 12 may be installed in the user base 14 or the external management unit 16.

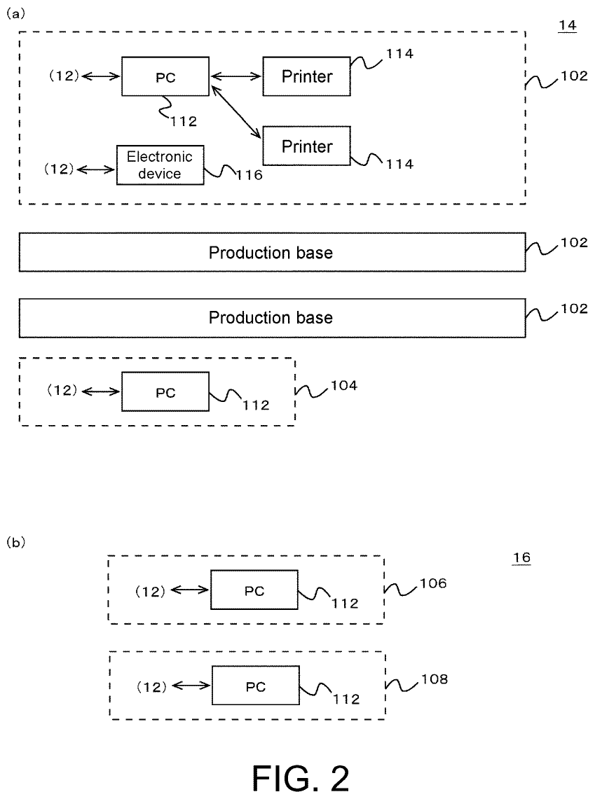

The user base 14 is a base where printing operation is executed in the printing system 10. The user base 14 can also be considered as a base or the like where a printer to be managed by the management server 12 is installed. Further, the user base 14 can also be considered as a base or the like managed by an administrator of the printer used in the printing system 10. The external management unit 16 is configured to manage at least a part of the printing system 10 outside the user base 14. The external management unit 16 of the present example is a base of an operator that provides services such as maintenance for the printer at the user base 14, and provides services such as maintenance for the printer at the user base 14 based on the printer information acquired from the management server 12. The external management unit 16 can also be considered as a base or the like managed by an administrator different from the administrator of the user base 14. Further, for example, the configurations illustrated in FIG. 2 can be used as the user base 14 and the external management unit 16.

FIG. 2 is a diagram describing specific configurations of the user base 14 and the external management unit 16. In FIG. 2, (a) illustrates an example of the configuration of the user base 14. In FIG. 2, (b) illustrates an example of the configuration of the external management unit 16. The user base 14 of the present example is a base where a product (printed matter) printed using a printer is produced, and includes a plurality of production bases 102 and a management department 104. The production base 102 is a base where a printer is installed. Further, the production base 102 of the present example includes a PC 112, a plurality of printers 114, and an electronic device 116. The PC 112 is a computer that controls the printing operation by the printers 114. Further, the PC 112 of the present example is a computer for RIP processing (RIP-PC), and controls the operation of the printers 114 by supplying data generated by the RIP processing to the printers 114. In this case, as illustrated in the figure, the operation of the plurality of printers 114 may be controlled by one PC 112.

Further, the PC 112 of the present example is an example of an electronic apparatus that performs display based on the printer information acquired from the management server 12, and includes a communication interface, a monitor, and the like. In this case, the communication interface can be considered as an example of a communication unit that receives printer information associated with the printer 114 managed by the PC 112 from the management server 12. Further, the monitor can be considered as an example of a display unit that displays information based on the printer information transmitted from the management server 12. In this case, it may be considered as an example of the display unit, including a configuration for controlling display content on the monitor. Further, the PC 112 of the present example further communicates with the printer 114 to acquire information of the printer 114, and transmits the information to the management server 12, thereby updating the printer information in the management server 12. In this case, the PC 112 can also be considered to have a configuration that detects the status of the printer 114 and notifies the management server 12 of the detected status. The PC 112 periodically detects the status of the printer 114 at a predetermined timing, and updates the printer information in the management server 12 based on the detected status. Further, in this case, the PC 112 may automatically execute the operation of detecting the printer 114 and updating the printer information regardless of the user's operation or the like.

The printer 114 is a printer for producing a product at the production base 102, and executes the printing operation according to control of the PC 112. Further, the printer 114 of the present example is a color printer that performs printing using a plurality of colors of ink. As the printer 114, an inkjet printer having the same or similar configuration as a known inkjet printer or the like can be preferably used.

The electronic device 116 is an information display device such as a smartphone, a tablet terminal, or a personal computer. Further, in the present example, the electronic device 116 is also an example of an electronic apparatus, and performs display based on the printer information acquired from the management server 12. In this case, the communication interface of the electronic device 116 can be considered as an example of a communication unit. Further, the screen of the electronic device 116 can be considered as an example of a display unit. In this case, it may be considered as an example of the display unit, including a configuration for controlling the display content on the screen. Further, the electronic device 116 of the present example can be considered as an electronic apparatus or the like that performs display based on the printer information without updating the printer information in the management server 12.

By using the production base 102 having such a configuration, display based on the printer information can be appropriately performed in the PC 112 and the electronic device 116. Further, the printer information of the management server 12 can be appropriately updated by the PC 112. The specific configuration of the production base 102 is not limited to the illustrated configuration, and may differ in various ways. For example, the number of printers 114 managed by the PC 112 may be one or three or more. Further, the number of PCs 112 and electronic devices 116 at one production base 102 may be more than one. Further, the number of PCs 112, printers 114, and electronic devices 116, the number of printers 114 managed by one PC 112, and the like may differ for each production base 102. Further, the number of production bases 102 is not limited to the illustrated number, and can be appropriately changed. Further, it is also conceivable, for example, to use a configuration, as the production base 102, in which the number of printers 114 in the printing system 10 is only one.

As described above, the user base 14 of the present example further includes the management department 104 in addition to the plurality of production bases 102. The management department 104 is a configuration for managing the plurality of production bases 102, and includes a PC 112. In the present example, the PC 112 in the management department 104 is also an example of an electronic apparatus that performs display based on the printer information acquired from the management server 12. The PC 112 is a computer for an administrator for the entire user base 14, and performs display based on the printer information acquired from the management server 12, similarly to the PC 112 at the production base 102. The PC 112 in the management department 104 can also be considered as an electronic apparatus or the like that performs display based on the printer information without updating the printer information in the management server 12.

Further, the external management unit 16 of the present example includes a marketing department 106 and a support department 108. The marketing department 106 is a department that provides articles and information related to the printer 114 to the user of the printer 114 at the user base 14. In this case, as provision of the articles related to the printer 114, for example, it is conceivable to sell ink, a medium, and the like. Further, for example, it is also conceivable to sell consumables and the like to be replaced during maintenance of the printer 114 in cooperation with the marketing department 106. The support department 108 is a department that provides maintenance service and the like to the user of the printer 114. Further, the marketing department 106 and the support department 108 of the present example include PCs 112. The PCs 112 in the marketing department 106 and the support department 108 are also an example of an electronic apparatus that performs display based on the printer information acquired from the management server 12. In this case, the marketing department 106 can perform marketing activities, and the like according to the status of the printer 114 by performing display based on the printer information on the PC 112. Further, in the support department 108, by performing display based on the printer information on the PC 112, the status of the printer 114 can be easily and appropriately grasped without visiting to the production base 102 or the like where the printer 114 is installed. As a result, it is possible to reduce the number of visits to the production base 102 and the like, to provide higher-quality maintenance service at low cost, and the like.

Here, as described above, in the printing system 10 of the present example, information is displayed on the PC 112 and the electronic device 116, which are examples of electronic apparatuses, based on the printer information managed by the management server 12. Such operation can be considered as an example of the operation of a display method for causing the electronic apparatus to display information. Further, in this case, the operation of transmitting the printer information from the management server 12 to the PC 112 or the electronic device 116 (hereinafter, referred to as the PC 112 or the like) can be considered as an example of the operation in the information transmission step. The information transmission step can be considered, for example, as a step in which the printer information associated with the printer 114 is transmitted from the management server 12 to the PC 112 or the like. Further, the operation of causing the PC 112 or the like to perform display based on the printer information transmitted from the management server 12 can be considered as an example of the operation in the display step. The display step can be considered as a step in which information based on the printer information transmitted from the management server 12 to the electronic apparatus in the information transmission step is displayed on the PC 112 or the like.

Further, in the PC 112 or the like, it is conceivable to perform display based on the printer information by, for example, a web browser (Internet browser). In this case, the management server 12 communicates with the PC 112 or the like using a predetermined protocol such as an HTTP protocol, and transmits data for displaying a web page to the PC 112 or the like in response to a request from the PC 112 or the like. Then, in this case, sending this data from the management server 12 to the PC 112 or the like can be considered as sending printer information or the like. Further, in this case, the PC 112 or the like performs display based on the printer information by displaying display based on the data sent from the management server 12 in a web browser. Depending on the configuration of the PC 112 or the like, display based on the printer information may be performed using, for example, a dedicated application program without using the web browser.

Further, in the printing system 10 of the present example, the operation of displaying information on the PC 112 or the like can be considered as being executed by a program executed in at least one of the management server 12, the PC 112, and the like. In this case, processing of transmitting information from the management server 12 to the PC 112 or the like according to this program can be considered as an example of information transmission processing. Further, the processing of causing the PC 112 or the like to perform screen display can be considered as an example of display processing. Further, in the present example, it can be considered that the management server 12 causes the PC 112 or the like to display information by sending data from the management server 12 to the PC 112 or the like according to a program executed in the management server 12. Further, it can also be considered that display based on the printer information is performed in the PC 112 or the like according to a program executed by the PC 112 or the like. Further, depending on the concept of relationship between the configuration and operation of the printing system 10 and the program, it can also be considered that information is displayed on the PC 112 or the like by both functions of the program executed by the management server 12 and the program executed by the PC 112 or the like.

Further, as can be understood from the above description and the like, in the present example, it can be considered that the printer 114 is managed by at least a part of the configuration in the printing system 10. Therefore, at least a part of the printing system 10 can also be considered as a management system or the like that manages the printer 114 in the printing system 10. In this case, this management system can be considered as a configuration or the like including the management server 12 in the printing system 10. The management system may be considered to further include a configuration other than the management server 12. In this case, it can be considered that the management system further includes the PC 112 or the like.

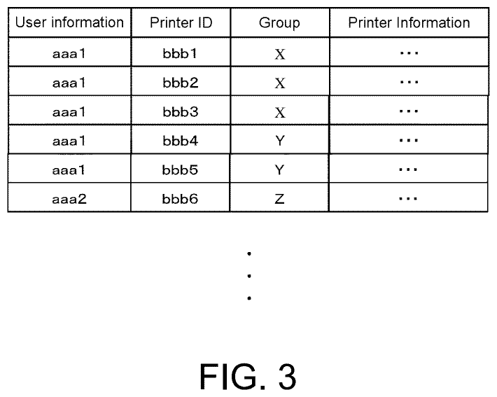

Next, the printer information and the like managed by the management server 12 will be described in more detail. FIG. 3 is a diagram describing how the printer information is managed by the management server 12, and illustrates an example of items managed in association with the printer information in a simplified manner. The management server 12 of the present example is a server accessed from the user base 14, the external management unit 16 (see FIG. 1), and the like, and manages the printer information while identifying the user of the printer 114 (see FIG. 2) by user authentication.

Further, the management server 12 of the present example manages correspondence relationship between the user and the printer 114 by associating user information for identifying the user registered in advance with a printer ID for identifying the printer 114. For example, in the case illustrated in FIG. 3, a plurality of printers 114 having printer IDs of bbb1 to bbb5 are associated with one user or one organization as a user whose user information is aaa1. In this case, the association between the user information and the printer 114 can be considered as an example of the association between the user and the printer 114. Further, in a case where the user information indicates an organization, the organization can be considered as a user or the like identified by the user information. Further, the printer 114 having a printer ID of bbb6 is associated with the user whose user information is aaa2. In the actual management server 12, it is conceivable to manage the association between the user and the printer 114 for more users.

Further, as in the present example, in a case where a plurality of printers 114 are associated with one user or one organization as a user, it is conceivable to manage the plurality of printers 114 by dividing them into groups, and the like. For example, in a case where the user base 14 has the plurality of production bases 102 (see FIG. 2), it is conceivable to divide the printers 114 into groups by grouping the printers 114 installed at the same production base 102, and the like. Further, in a case where there are a plurality of operators who perform work according to instructions of the user to whom the plurality of printers 114 are associated in the production base 102, it is also conceivable to group the printers 114 by operator, or the like. Therefore, the management server 12 of the present example makes it possible to manage the plurality of printers 114 by dividing them into groups by associating the groups with the printer IDs. For example, in the case illustrated in the figure, the plurality of printers 114 having the printer IDs of bbb1 to bbb3 belong to group X. The plurality of printers 114 having the printer IDs of bbb4 to bbb5 belong to group Y. Further, the printer 114 having the printer ID of bbb6 belongs to group Z.

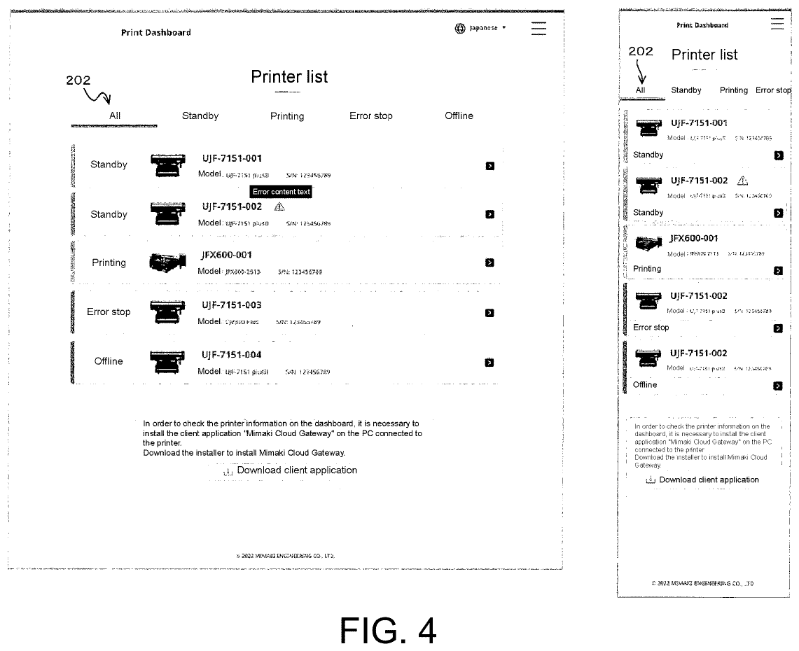

Further, the management server 12 of the present example associates the printer information for each printer 114 identified by the printer ID. As the printer information, various information regarding the status and the past history of the printer 114 can be used. According to the present example, the printer information corresponding to the printer 114 can be appropriately managed. Further, as a result, management and the like of the printer 114 can be appropriately performed using the printer information. Further, in this case, it is conceivable that the PC 112 or the like displays a list of the printers 114 associated with the user, the status of the printer 114, and the like based on the printer information. Further, in this case, it is conceivable that the PC 112 or the like displays a list of the printers 114 in association with the display of the status, for example, as illustrated in FIG. 4.

FIG. 4 is a view illustrating exemplary display screens in a case where a list of the printers 114 is displayed on the PC 112 or the like, and illustrates examples of two types of display screens selected according to the electronic apparatus that displays the screen. The view on a left side of the figure illustrates an example of a display screen in a case where display is performed on a large screen, for example, in a case where a personal computer or the like is used as the PC 112 or the electronic device 116. The view on a right side illustrates an example of a display screen in a case where display is performed on a narrow screen using a smartphone or the like as the electronic device 116. Further, in this case, it can be considered that the examples of screen displays on both the left and right sides display substantially the same content according to the purpose of the screen display.

Further, in a case where the PC 112 or the like of the present example is caused to perform the screen display, the user who operates the PC 112 or the like performs user authentication on the management server 12 (see FIG. 1) to sign in to the management server 12. Then, the PC 112 or the like displays information on the printer 114 associated with the user authenticated by the user authentication on the screen. Further, in this case, the PC 112 or the like having the display screen displaying a list of the printers 114 lists and displays information indicating the printers 114 associated with the user as illustrated in the figure. In the case illustrated in FIG. 4, the PC 112 or the like displays the name, model, operation status, and the like of the printers 114 for all the printers 114 associated with the user. In this case, the name of the printer 114 can be considered as a printer name or the like determined by the user to identify the printer 114. Further, the operation status can be considered as information and the like indicating what kind of status the printer 114 is in in relation to the printing operation. As the operation status of the present example, information indicating whether the status is printing, standby, error stop, or offline is used. In this case, the printing status can be considered as a status in which printing is being executed in the printer 114, or the like. The standby status can be considered as a status in which the printer 114 is waiting and ready to start printing, or the like. The error stop status can be considered as a status in which the printer 114 is stopped due to some error, or the like. The offline status can be considered as a status in which the status of the printer 114 cannot be acquired, or the like. Further, the offline status can also be considered as a status in which the management server 12 cannot grasp the latest status of the printer 114, or the like. In this case, the offline status can be considered as a status in which the printer 114 is not powered on, a status in which the status of the printer 114 cannot be grasped due to a problem of a communication path, the management server 12, or the like. Further, the offline status of the present example can also be considered as a status in which the latest status of the printer 114 cannot be acquired from the management server 12, or the like.

Further, the PC 112 or the like of the present example can also display a list of the printers 114 for each status of the printers 114 by display using tabs 202. In this case, the PC 112 or the like displays a list of the printers 114 in a status that is associated with the corresponding tab 202 according to the user's operation of selecting from the tabs 202. In the case illustrated in the figure, the PC 112 or the like displays the tabs 202 for switching display between all, standby, printing, error stop, and offline. In this case, when the tab 202 corresponding to all is selected, all the printers 114 associated with the user are displayed. Further, when other tab 202 is selected, the printer 114 in a status corresponding to the selected tab 202 among the printers 114 associated with the user is displayed. With this configuration, the status and the like of the printers 114 managed by the user can be easily and appropriately checked.

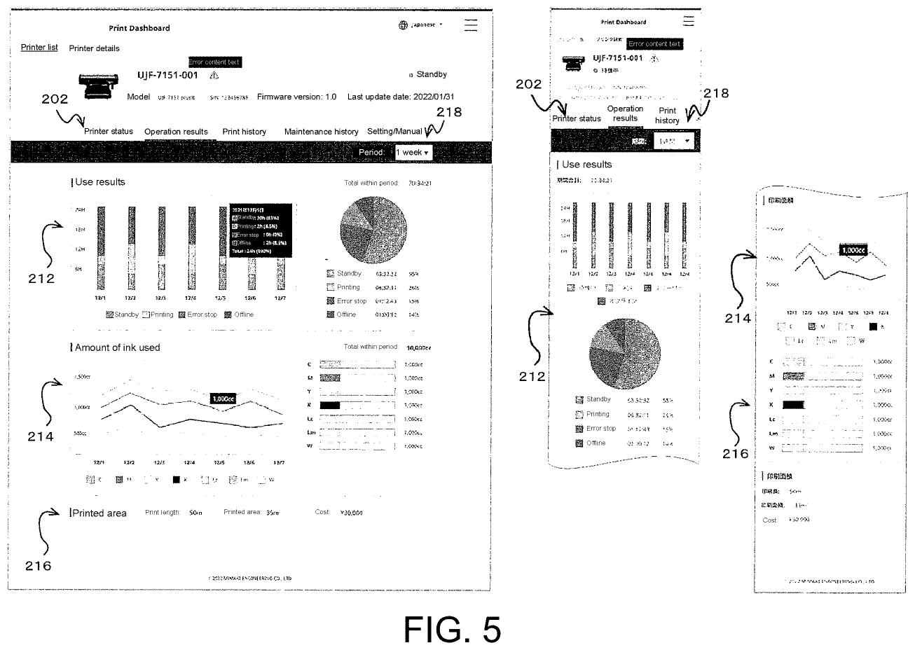

Further, the PC 112 or the like of the present example can also display more detailed information regarding the printer 114 based on the printer information received from the management server 12. In this case, it is conceivable to cause the PC 112 or the like to display information based on the printer information for the printer 114 selected by the user from a list of the printers 114. Further, in this case, for example, it is conceivable to cause the PC 112 or the like to display information as illustrated in FIG. 5.

FIG. 5 is a view illustrating exemplary display screens to be displayed on the PC 112 or the like, and illustrates examples of information to be displayed based on the printer information for the printer 114 selected by the user. Similarly to FIG. 4, FIG. 5 illustrates examples of two types of display screens selected according to the electronic apparatus that displays the screen as an example of the display screen. As described above, the management server 12 of the present example manages the printer information in association with the printer 114. Further, in a case where the screen display illustrated in FIG. 5 is performed on the PC 112 or the like, the management server 12 manages, as the printer information, at least operation information indicating the operation status of the printer 114, ink usage information indicating the amount of ink used in the printer 114, and printed area information indicating a printed area, which is an area where printing has been performed in the printer 114, in association with the printer 114. Further, in this case, the management server 12 transmits at least the printer information including these pieces of information to the PC 112 or the like in response to a request from the PC 112 or the like. Then, the PC 112 or the like displays the aggregation of operation status, the aggregation of the amount of ink used, and the aggregation of the printed area on one screen based on these pieces of information sent from the management server 12.

In this case, as for displaying these aggregations on one screen, it is considered that display is performed in a status that can be handled as one screen in the PC 112 or the like. For example, in a case where the screen display is performed in a web browser on the PC 112 or the like, it can be considered that display corresponding to one screen in the web browser is performed, and the like. Further, one screen in the web browser can be considered as a range or the like that can be displayed without moving between pages. The range that can be displayed without moving between pages can be considered as a range or the like that can be displayed without changing the URL. Further, in a case where the above aggregations are displayed by the PC 112 or the like, the aggregation of operation status, the aggregation of the amount of ink used, the aggregation of the printed area, and the like may be directly transmitted from the management server 12 to the PC 112 or the like. In this case, transmitting these aggregations can be considered as transmitting printer information including the operation information, the ink usage information, the printed area information, and the like.

Further, in the PC 112 or the like of the present example, as illustrated in the figure, a screen showing the tabs 202, an operation information display part 212, an ink usage display part 214, a printed area display part 216, and a period setting part 218 is displayed as one screen. In this case, the tab 202 is a selection part for receiving selection of items to be displayed in association with the printer 114. Further, the PC 112 or the like of the present example displays the tabs 202 for switching the display among the printer status, the operation results, the print history, the maintenance history, and the setting/manual. Further, FIG. 5 illustrates an example of a screen in a case where the tab 202 of the operation results is selected from these.

The operation information display part 212 is a portion that displays the aggregation of operation status. Further, as described above, information indicating whether it is printing, standby, error stop, or offline is used as the operation status of the present example. Therefore, the PC 112 or the like displays, as the aggregation of operation status, the aggregation of the printing period during which the printer 114 was printing, the standby period indicating a period during which the printer 114 was on standby, the error stop period during which the printer 114 was in error stop, and the offline period during which the printer 114 was offline on the operation information display part 212. The aggregation of these periods can be considered as aggregation of time periods during which the printer 114 was in the corresponding operation status, and the like. The aggregation of the printing period can be considered as aggregation of the period during which printing was executed by the printer 114, and the like. The aggregation of the standby period can be considered as aggregation of the period during which the printer was in a standby status, and the like. The aggregation of the error stop period can be considered as aggregation of the period during which the printer 114 was stopped due to an error, and the like. The aggregation of the offline period can be considered as aggregation of the period during which the information of the printer 114 could not be acquired, and the like. With this configuration, the operation status of the printer 114 can be appropriately grasped.

Further, as illustrated in the figure, the PC 112 or the like of the present example displays a bar graph and a pie chart indicating the time period during which the printer was in each of a plurality of types of status (operation status) of the printer 114 as the aggregation of operation status. With this configuration, it is possible to cause the PC 112 or the like to appropriately perform display that facilitates grasping of the operation status. Further, as a result, the aggregation of operation status of the printer 114 can be appropriately grasped. Further, in this case, the PC 112 or the like directly indicates the time period for each operation status by the bar graph, and indicates a ratio of the time period for each operation status by the pie chart. By using two types of graphs, a bar graph and a pie chart, it is possible to allow the user to grasp the operation status of the printer 114 in detail and appropriately. Further, in the present example, it can be considered that the operational status of the printer 114 is visualized by causing the PC 112 or the like to display the aggregation of operation status corresponding to the printer 114. Further, in this case, by visualizing the operational status of the printer 114, it is possible to make improvements that increase the productivity of the printer 114, leading to efficient production and the like. Further, the manner of display on the operation information display part 212 is not limited to the illustrated manner of display, and can be changed in various ways. For example, the bar graph is not limited to a vertical bar graph as illustrated in the figure, and a horizontal bar graph may be used. Further, it is also conceivable to display only one of the bar graph and the pie chart on the operation information display part 212 according to the purpose of displaying information or the like.

The ink usage display part 214 is a portion that displays the aggregation of the amount of ink used. The PC 112 or the like of the present example displays a line graph and a bar graph on the ink usage display part 214 as the aggregation of the amount of ink used, as illustrated in the figure. In this case, the PC 112 or the like displays the amount of ink used for each color in time series by the line graph. Further, the amount of ink used for each color over a total period is displayed by the bar graph. With this configuration, the aggregation of the amount of ink used can be appropriately grasped. Further, the manner of display on the ink usage display part 214 is not limited to the illustrated manner of display, and can be changed in various ways. For example, the bar graph is not limited to a vertical bar graph as illustrated in the figure, and a horizontal bar graph may be used. Furthermore, it is also conceivable to display only one of the line graph or the bar graph on the ink usage display part 214 according to the purpose of displaying the information, and the like. Further, for the aggregation of the amount of ink used, it is also conceivable to display the aggregation of the amount of ink used in the total amount of ink used obtained by aggregating all the colors of the plurality of colors of ink, and the like, instead of for each color. In this case, for the aggregation of the amount of ink used, the PC 112 or the like displays either or both of the aggregation of the amount of ink used for each color and the aggregation of the amount of ink used in the total amount of ink used obtained by aggregating all the colors of the plurality of colors of ink according to the user's selection. With this configuration, the amount of ink used when using the plurality of colors of ink can be more appropriately grasped. Further, by displaying the aggregation of the amount of ink used in the total amount of ink used obtained by aggregating all the colors, the cost of all the colors can be more easily calculated in a case such as where the cost of printing is estimated.

The printed area display part 216 is a portion that displays the aggregation of the printed area. The PC 112 or the like of the present example displays a print length, the printed area, and the cost on the printed area display part 216 in association with the aggregation of the printed area. In this case, the aggregation of the printed area can be considered as a parameter or the like that increases according to the amount of medium consumed. With this configuration, the aggregation of the printed area can be appropriately grasped. Further, the manner of display on the printed area display part 216 is not limited to the illustrated manner of display, and can be changed in various ways. A bar graph or a line graph may be displayed for the aggregation of the printed area. As the bar graph, it is conceivable to use a vertical bar graph or a horizontal bar graph. With this configuration, the aggregation of the printed area can be intuitively grasped. Further, the PC 112 or the like may divide and display the aggregation of the printed area for each category in a plurality of preset categories. With this configuration, more various information regarding the aggregation of the printed area can be displayed. Further, in this case, as the display for each category, it is conceivable to perform display for each medium used for printing, display for each print data, and the like.

The period setting part 218 is a portion for receiving designation of a period for aggregation from the user. The PC 112 or the like of the present example, through the period setting part 218, receives designation of the aggregation period (display period) from the user who operates the operation information display part 212 and the like for the aggregation of operation status, the aggregation of the amount of ink used, and the aggregation of the printed area. The period setting part 218 can be considered, for example, as a configuration for receiving designation of a period in a user interface (UI) of the PC 112 or the like. Further, the operation of receiving the designation of the period by the period setting part 218 can be considered as an example of the operation in an aggregation period setting step. The aggregation period setting step can be considered, for example, as a step of setting an aggregation period corresponding to information to be displayed on the PC 112 or the like. In a case where the period setting part 218 of the present example receives the designation of the period from the user, the PC 112 or the like performs display on the operation information display part 212, the ink usage display part 214, and the printed area display part 216 according to the designated period. Further, in a case where the designated period is changed by the operation of the period setting part 218, the PC 112 or the like updates the display on the operation information display part 212, the ink usage display part 214, and the printed area display part 216 according to the newly designated period.

Further, the period setting part 218 of the present example collectively receives the same period as the aggregation period for the operation information display part 212, the ink usage display part 214, and the printed area display part 216. However, the method of accepting the designation of the period in the period setting part 218 is not limited to collective setting, and may be performed by a method of performing individual setting. In this case, the PC 112 or the like allows the user to select whether to set the periods collectively or individually, and then receives designation of the period from the user. As a result, the PC 112 or the like displays the aggregation for the designated period. With this configuration, even when it is desired to change only the aggregation period of some items when considering aggregation results and the like, the aggregation period can be appropriately changed. Further, in this case, when setting the period using the period setting part 218, the PC 112 or the like collectively or individually receives the setting for the period during which the aggregation of operation status is performed, the period during which the aggregation of the amount of ink used is performed, and the period during which the aggregation of the printed area is performed, according to the user's selection. Further, when displaying on the operation information display part 212, the ink usage display part 214, and the printed area display part 216, the PC 112 or the like displays the aggregation of operation status, the aggregation of the amount of ink used, and the aggregation of the printed area according to the period set when setting the period. With this configuration, the aggregation period can be appropriately changed according to the user's desire. Further, by collectively or individually setting the display manner, it is possible to more appropriately check the status of the printer 114, perform various examinations, and the like.

As described above, according to the present example, the status and the like of the PC 112 can be appropriately grasped by performing display on the PC 112 or the like based on the printer information acquired from the management server 12. Further, in this case, the status of the printer 114 can be easily and appropriately grasped by causing the PC 112 or the like to display the aggregation of operation status, the aggregation of the amount of ink used, and the aggregation of the printed area on one screen. Further, as a result, it is possible to easily and appropriately check whether or not the printer 114 is stably operating, and the like. Further, in a case where a problem occurs in the status of the printer 114, it is also possible to collectively grasp useful information for grasping the problem.

Further, in this case, it can also be considered that the information that the user wants to see can be efficiently and appropriately displayed regarding management of the user for the printer 114 and various determinations related to the printer 114 by displaying related information together on one screen. For example, by displaying the aggregations of operation status, the amount of ink used, and the printed area together, it is possible to easily and appropriately grasp an overall status of the printer 114 and to easily make a comprehensive determination as to whether or not a problem has occurred in the printer 114. Further, in this case, even a user who is not near the printer 114, such as a user who checks information in the management department 104 at the user base 14 or the external management unit 16, can easily and appropriately check the status and the like of the printer 114. Further, even a user (an operator) who directly uses the printer 114 at the production base 102 can appropriately check the status and the like of the printer 114 at a position away from the printer 114 by using, for example, the electronic device 116. As a result, in a case where the printer 114 is continuously operated for a long time or the like, it is possible to perform another work or the like at a position away from the printer 114. Therefore, according to the present example, it is also possible to appropriately improve work efficiency at the production base 102, and the like.

Furthermore, in the present example, by displaying the aggregation of the amount of ink used and the aggregation of the printed area on one screen, it is possible to easily and appropriately determine whether the amount of ink used is appropriate for the printed area, and the like. Further, for example, in a case where the amount of ink used changes due to an abnormality in the printer 114 or the like, it is also possible to detect the abnormality due to a change in the relationship (balance) between the printed area and the amount of ink used displayed on one screen, and the like. Further, as described above, the aggregation of the printed area can be considered as a parameter that increases according to the amount of medium consumed, and the like. Therefore, by displaying the aggregation of the amount of ink used and the aggregation of the printed area on one screen, the consumption amount for the ink and the medium consumed by the printing operation can be displayed together. As a result, it is possible to collectively grasp information that is useful when considering the running cost and the like of the printer 114.

Further, in the aggregation of operation status, it is possible to check whether or not the work performed using the printer 114 is proceeding as planned by indicating the time period during printing, standby, error stop, and offline. Further, it is also possible to perform, for example, labor management related to the work performed using the printer 114 at the production base 102 based on these ratios. Furthermore, by displaying the aggregation of operation status on one screen together with the aggregations of the amount of ink used and the printed area, it is also possible to determine the efficiency of work depending on the manner of work, and the like. For example, in a case where there is a difference in the amount of ink consumed by the printer 114 required to achieve the same printed area, it is possible to examine an influence of the manner of work and the like by confirming the relationship with the aggregation of operation status.

Further, the PC 112 or the like may display the aggregation of operation status, the aggregation of the amount of ink used, and the aggregation of the printed area by a method different from the above. For example, the PC 112 or the like may display a plurality of the aggregation of operation status, the aggregation of the amount of ink used, and the aggregation of the printed area in one graph. With this configuration, a correlation and the like between a plurality of aggregation targets can be easily and appropriately grasped. Further, in this case, it is conceivable to display the aggregation of operation status and the aggregation of the amount of ink used in one graph to confirm the correlation between the two, and the like.

Further, the PC 112 or the like may display various numerical values or the like according to the user's operation. In this case, for example, it is conceivable that when the user places a cursor on the graph, the PC 112 or the like is caused to display a numerical value corresponding to the position. In this case, the PC 112 or the like displays, for example, a cursor that moves according to the user's operation, and a graph indicating at least one of the aggregation of operation status, the aggregation of the amount of ink used, and the aggregation of the printed area. Then, in a case where the cursor is positioned on the graph by the user's operation, the PC 112 or the like displays a numerical value corresponding to the position of the cursor in the graph. With this configuration, more detailed information can be displayed to the user. Further, in this case, it is conceivable to cause the PC 112 or the like to display a value for each time, a value for each day, an accumulated value, a value on the vertical axis, a value on the horizontal axis, or the like as a numerical value. Further, the PC 112 or the like may display the maximum value and the minimum value of the graph in a conspicuous manner. In this case, the PC 112 or the like displays a graph indicating at least one of the aggregation of operation status, the aggregation of the amount of ink used, and the aggregation of the printed area, and makes the display manner of the maximum value and the minimum value of the graph different from other values. In this case, for example, it is conceivable to change the display of the color, shape, or the like for the maximum value or the minimum value during the aggregation period. With this configuration, it is possible to easily grasp the position of the maximum value or the minimum value in the graph.

Further, in FIG. 5, the PC 112 or the like displays the aggregation for one printer 114 for the aggregation of operation status, the aggregation of the amount of ink used, and the aggregation of the printed area. On the other hand, the PC 112 or the like may display aggregation of information on the plurality of printers 114 for these aggregations. In this case, these aggregations can be considered as aggregations or the like obtained by aggregating the plurality of printers 114 in a designated period. Further, in this case, it is conceivable, for example, to set the group associated with the printers 114 in the management server 12 as a unit of the plurality of printers 114. In this case, the PC 112 or the like receives designation of a group as a unit of aggregation from the user. Further, it is also conceivable to use a plurality of printers 114 designated regardless of the group as the plurality of printers 114 serving as the unit of aggregation, and the like. Further, the PC 112 or the like may display aggregation of information on all the printers 114 associated with the same user.

Using the inkjet printer as the printer 114 used in the printing system 10 has been described above. However, as the printer 114 used in the printing system 10, a printer other than the inkjet printer may be used. Further, for example, it is also conceivable to use a 3D printer as the printer 114 used in the printing system 10. In this case, it is conceivable to use a total area of ink layers formed by the ink used as a material of shaping for the printed area.

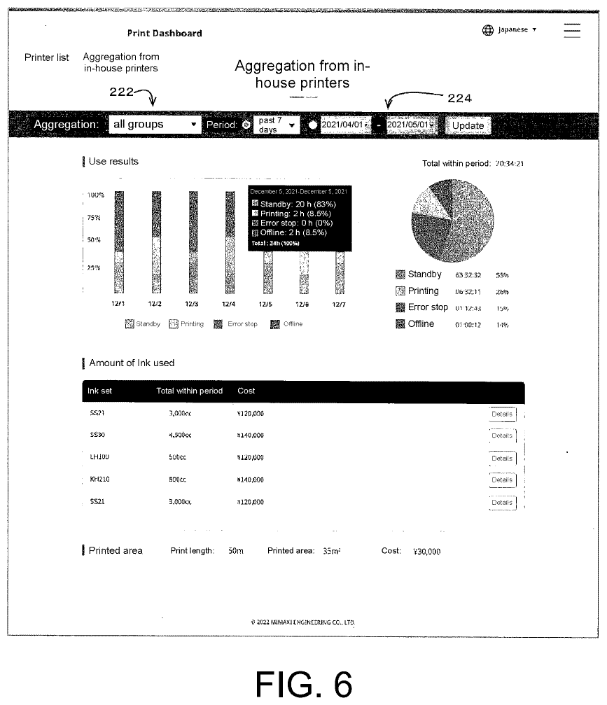

Further, the PC 112 or the like of the present example can also display more detailed information regarding the printer 114 based on the printer information received from the management server 12. In this case, for example, it is conceivable to cause the PC 112 or the like to display information based on the printer information for the printer 114 selected by the user from a list of the printers 114. Further, as the display of the information on the printer 114, all the printers 114 associated with the user, the printers 114 or the like included in the group, or the like are collectively selected, so that the information on the plurality of printers 114 may be displayed on the PC 112 or the like, for example, as illustrated in FIGS. 6 to 8.

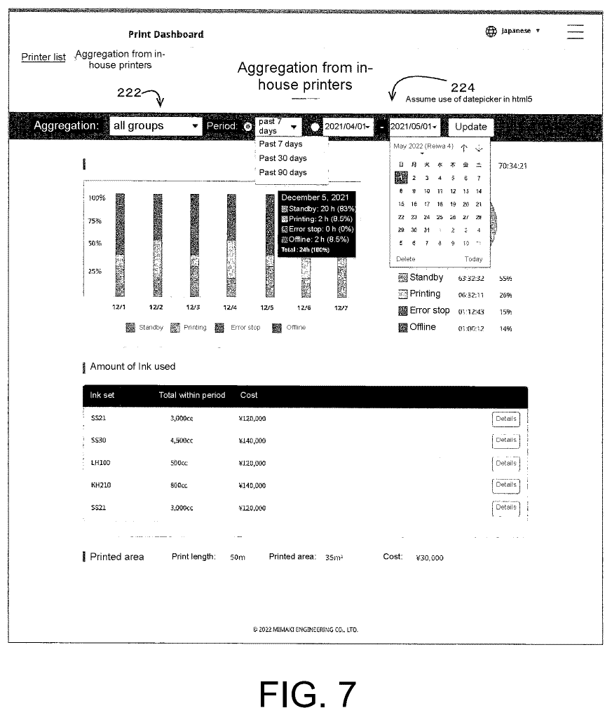

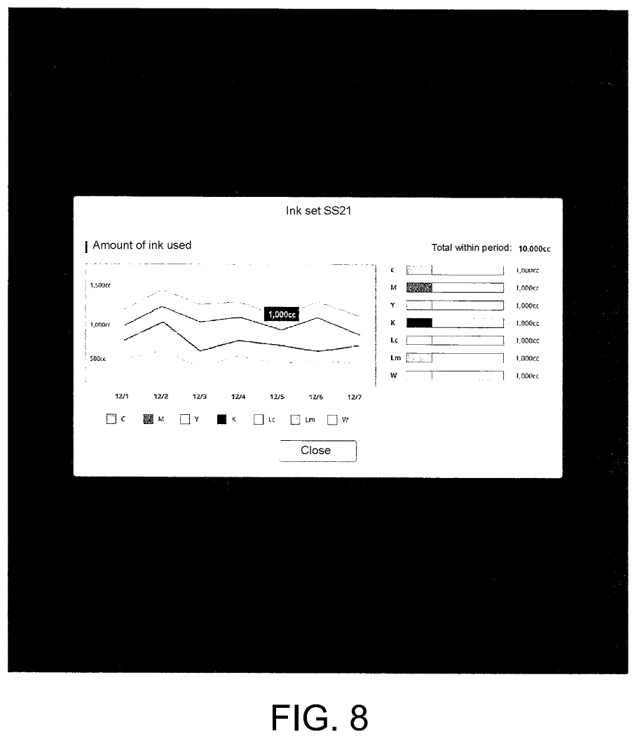

FIGS. 6 to 8 are views illustrating examples of display screens to be displayed on the PC 112 or the like, and illustrate examples of information to be displayed based on the printer information regarding a plurality of printers 114 selected by the user. FIG. 6 illustrates an example of information to be displayed for the plurality of printers 114. FIG. 7 illustrates an example of how to change the aggregation period during which aggregation for information to be displayed is performed. FIG. 8 illustrates an example of a display screen showing more detailed information about a part of the information on the printer 114. For convenience of illustration, FIGS. 6 to 8 illustrate only examples of screens corresponding to one of two types of screen display illustrated in FIG. 4.

Further, as indicated by letters “aggregation from in-house printers” in the figure, FIGS. 6 and 7 illustrate status of the printers 114 aggregated for the printers 114 in one organization. In this case, the printer 114 in one organization can be considered as the printers 114 or the like managed in association with the same user in the management server 12. Further, the display screen of the aggregation from in-house printers can be considered as an example of a display screen displayed by the PC 112 or the like according to the user's instruction in a case where a plurality of printers 114 are associated with one user or one organization as a user. In regard to the fact that a plurality of printers 114 are associated with one user or one organization as a user, it can be considered as the fact that a plurality of printers 114 are registered in association with the same user in the management server 12, and the like.

Further, the PC 112 or the like of the present example displays a screen including a display target selection part 222 and a period setting part 224 as illustrated in the figure as a screen display related to the aggregation from in-house printers. In this case, the display target selection part 222 is a selection part for selecting the printers 114 to be aggregated for the items displayed on the screen display of the PC 112 or the like. In the present example, in a case where a plurality of printers 114 are associated with the user, the display target selection part 222 receives, from the user, selection of any one of all the printers 114, the grouped printers 114, and the individual printers 114 for the printers 114 to be the aggregation target. In this case, all the printers 114 can be considered as all the printers 114 or the like associated with the user who operates the PC 112 or the like. The user who operates the PC 112 or the like can be considered as a user who signs in to the management server 12 in order to operate the PC 112 or the like. Further, the grouped printers 114 are at least a part of all the printers, and can be considered as the printers 114 or the like belonging to the same group. The individual printers 114 can be considered as the individual printers 114 or the like included in all the printers 114. Further, FIGS. 6 and 7 illustrate a status in which “all groups” is selected in the display target selection part 222. In this case, the selection of all the groups can be considered to correspond to the selection of all the printers 114.

The PC 112 or the like performs screen display based on the printer information for at least one of the full display, the group display, and the display for each printer according to the user's selection in the display target selection part 222. In this case, the full display can be considered as displaying information on all the printers 114 associated with the user. The group display can be considered as displaying information on the printers 114 included in any of the groups. The display for each printer can be considered as displaying information on the individual printers 114. Further, in the present example, the full display is screen display performed in a case where all the printers 114 are selected. The group display is screen display performed in a case where the grouped printers 114 are selected. The display for each printer is screen display performed in a case where the individual printers 114 are selected. Further, in a case where the management server 12 manages a plurality of printers 114 associated with a user who operates the PC 112 or the like, the PC 112 or the like selects which one of a plurality of types of display manners that include the full display, the group display, and the display for each printer is to be performed according to the user's instruction regarding display manner based on the printer information. In this case, this selection can be considered as selection of performing at least one of the full display, the group display, and the display for each printer.

Further, FIGS. 6 and 7 illustrate an example of a case where any one of the full display, the group display, and the display for each printer is selected and displayed for the screen display of the PC 112 or the like. Further, in FIGS. 6 and 7, the PC 112 or the like displays the aggregation of operation result of the printers for all the printers 114 (the printers 114 of all the groups). Further, as the aggregation of operation result, the aggregation of use result, the amount of ink used, and the printed area is displayed. The aggregation of use result of the printer 114 can be considered as aggregation of operation status of the printer 114, and the like. Further, as illustrated in the figure, the PC 112 or the like of the present example displays the time period and ratio of standby, printing, error stop, and offline status in the aggregation period as the aggregation of operation status. The aggregation of the amount of ink used can be considered as aggregation of the amount of ink used in the printer 114 to be aggregated. Further, as illustrated in the figure, the PC 112 or the like of the present example displays the amount of ink used and the cost over the total period for each ink set as the aggregation of the amount of ink used. Further, the PC 112 or the like further displays a button for indicating more detailed information for each ink set. The aggregation of the printed area can be considered as aggregation of area where printing has been performed by the printer 114 to be aggregated. Further, the PC 112 or the like of the present example displays the print length, the printed area, and the cost as the aggregation of the printed area as illustrated in the figure. With this configuration, in a case where a plurality of printers 114 are associated with one user or one organization as a user, the status of the plurality of printers 114 can be appropriately grasped as necessary. Further, as a result, the printer 114 can be managed more easily and appropriately.

Further, in the screen display illustrated in FIGS. 6 and 7, the aggregation period of the information on the printer 114 can be changed using the period setting part 224. The period setting part 224 is a setting part for setting an aggregation period during which aggregation is performed in the items displayed on the screen display of the PC 112 or the like. The period setting part 224 can also be considered as a configuration or the like for receiving designation of a period in a user interface (UI) of the PC 112 or the like. Further, as illustrated in FIG. 7, for example, the period setting part 224 of the present example sets the aggregation period by receiving a manner of setting the period and designation of the period from the user. With this configuration, the aggregation period desired by the user can be appropriately set. Further, as a result, the status of the printer 114 can be checked more appropriately.

Further, as described above, the PC 112 or the like of the present example further displays a button for indicating more detailed information for each ink set regarding the aggregation of the amount of ink used. Then, in a case where the button corresponding to any one of the ink sets is pressed by the user, the PC 112 or the like displays more detailed information regarding the ink set, for example, as illustrated in FIG. 8. With this configuration, cost management and the like regarding the ink can be more appropriately managed.

Here, a method of screen display by the PC 112 or the like will be described in more detail. In the present example, in a case where a plurality of printers 114 is associated with the user, the PC 112 or the like receives, from the user, an instruction to select which of all the printers 114, the grouped printers 114, and the individual printers 114 is to be the target, as described above. With this configuration, the printer 114 for which information is displayed can be appropriately changed according to the content that the user wants to check. Further, as a result, in a case where the information on the plurality of printers 114 is managed by the management server 12, the information required by the user can be appropriately displayed on the PC 112 or the like.

Further, in FIG. 6 and the like, an example of a case of selecting any one of display manners corresponding to the full display, the group display, and the display for each printer and performing display is illustrated as display manner of information by the PC 112 or the like. On the other hand, the PC 112 or the like may further display the information by a method different from that in FIG. 6 or the like, for example, according to the user's selection or the like. In this case, the PC 112 or the like selects whether to display the information in a list (collectively) or individually according to the user's instruction. The PC 112 or the like of the present example selects one of the batch display and the individual display according to the user's instruction regarding the display manner of the full display, the group display, and the display for each printer, and displays the information based on the printer information. In this case, the batch display can be considered as display in which the full display, the group display, and the display for each printer are performed on one screen. The individual display can be considered as display in which any one of the full display, the group display, and the display for each printer is selected and displayed.

Further, in this case, as for displaying a plurality of items on one screen in the PC 112 or the like, it is considered that display is performed in a state that can be handled as one screen in the PC 112 or the like. For example, in a case where the screen display is performed in a web browser of the PC 112 or the like, it can be considered that display corresponding to one screen in the web browser is performed. Further, one screen in the web browser can be considered as a range or the like that can be displayed without a page transition. The range that can be displayed without the page transition can be considered as a range or the like that can be displayed without changing the URL. According to the present example, in a case where the management server 12 manages a plurality of printers 114 associated with the user, the display manner based on the printer information can be appropriately selected from a plurality of methods according to the purpose of checking the information and the like. Further, as a result, it is possible to more appropriately indicate information required by the user to the user.

Further, in a case of performing the group display, the PC 112 or the like displays aggregation information of the group or the information of the individual printers 114 belonging to the group according to the user's selection. In this case, the aggregation information of the group can be considered as information obtained by aggregating the printers 114 included in the same group. The information of the individual printers 114 belonging to the group can be considered as information for each printer 114 included in the group. With this configuration, the information on the group can be appropriately displayed according to the user's desire.

Further, the PC 112 or the like may display aggregation display related to the aggregation in a group unit or the like and the display for each printer 114 related to the individual printers 114 on one screen, for example, according to the user's selection. In this case, the aggregation display can be considered as display or the like obtained by aggregating information on a plurality of printers 114 associated with the user. The display for each printer can be considered as display of information on individual printers, and the like. Further, in this case, the aggregation display is not limited to the display for each group, and the aggregation for all the printers 114 may be displayed. In this case, the PC 112 or the like displays at least one of the group aggregation display and the full aggregation display in the aggregation display, for example, according to the user's selection. Further, the group aggregation display can be considered as display or the like in which information on the printers 114 included in the same group is aggregated. The full aggregation display can be considered as display or the like in which information on all the printers 114 associated with the user is aggregated. Further, in this case, the PC 112 or the like performs only one of the group aggregation display and the full aggregation display as the aggregation display according to the user's instruction. Also, for example, it is conceivable to perform both the group aggregation display and the full aggregation display as the aggregation display according to information or the like desired by the user. With this configuration, information required by the user can be appropriately displayed on the PC 112 or the like. Further, as a result, the status of the printer 114 can be more appropriately grasped.

Further, in the present example, the printers 114 associated with the user are divided into groups by user manual setting by the user's operation or automatic setting based on a preset rule. With this configuration, grouping of the printers 114 can be appropriately performed. Further, in this case, for grouping in the automatic setting, it is conceivable to perform grouping according to at least one of uses of the printer 114, timing for introduction of the printer 114, the maintenance history for the printer 114, the operation result of the printer 114, a production target set in the printer 114, and the like. Further, grouping from these viewpoints can be performed in the same way in grouping by the manual setting. Further, for example, in a case of focusing on how the printer 114 is used, it is conceivable to divide the printers 114 associated with the user into groups by production line that produces a product using the printer 114 or by product. With this configuration, grouping can be appropriately performed according to how to use the printer 114 and the like. Further, as a result, it is possible to facilitate the aggregation of the production output and costs for the production of the product performed using the printer 114.

As described above, according to the present example, the status of the PC 112 and the like can be appropriately grasped by performing display based on the printer information acquired from the management server 12 by the PC 112 or the like. Further, in a case where a plurality of printers 114 are associated with the user, information required by the user can be appropriately displayed on the PC 112 or the like by using a display manner such as the full display, the group display, and the display for each printer. Further, as a result, the status of the plurality of printers 114 and the like can be easily and appropriately grasped.

Further, regarding the information displayed based on the print information, the PC 112 or the like may display other information not limited to the information illustrated in FIG. 6 and the like. The PC 112 or the like may display at least one of the printer outline indicating the outline of the printer, the printer status indicating the status of the printer, the operation result of the printer, and the maintenance history for the printer based on the printer information. In this case, it is conceivable to make it possible to select screen display related to other information on a screen or the like on which selection to display the display screen illustrated in FIG. 6 or the like is performed. With this configuration, the status of the printer 114 can be more appropriately checked based on the printer information.

Further, in the above description, for example, using the inkjet printer has been described for the printer 114 used in the printing system 10. However, as the printer 114 used in the printing system 10, a printer other than the inkjet printer may be used. Further, for example, it is also conceivable to use a 3D printer as the printer 114 used in the printing system 10.

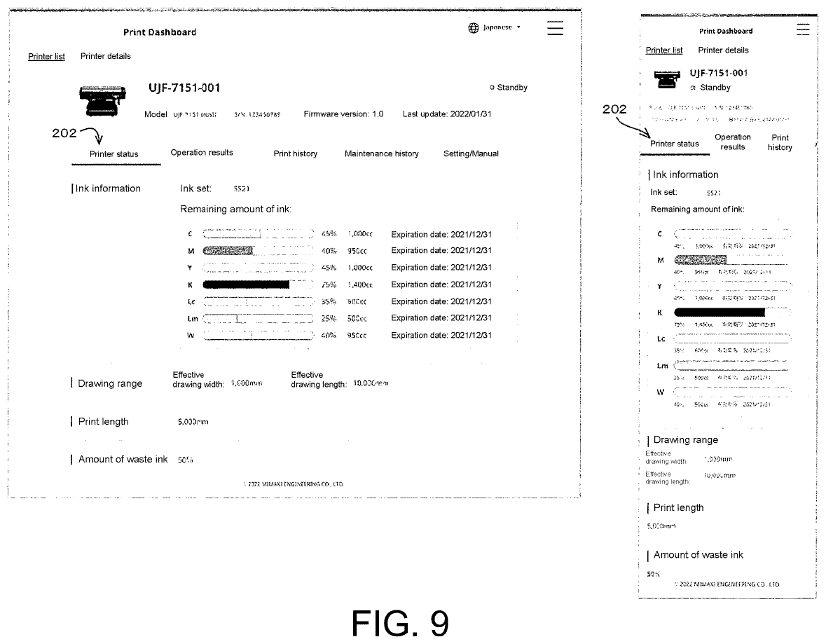

Further, for example, as illustrated in FIGS. 9 to 13, the PC 112 or the like may switch and display a plurality of types of information according to the user's operation. FIGS. 9 to 13 illustrate another example of information displayed regarding the printer 114 by the PC 112 or the like. Similarly to FIG. 4, FIGS. 9 to 13 also illustrate an example of two types of display screens selected according to the electronic apparatus that displays the screen as an example of the display screen. As illustrated in these figures, the PC 112 or the like of the present example displays information on the printer status, the operation result, the print history, the maintenance history, and the setting/manual for the printer 114 based on the printer information received from the management server 12, for example, according to the user's instruction. Further, the PC 112 or the like switches and displays these pieces of information as detailed information (printer details) regarding the printer 114 by display using the tab 202 according to the user's operation on the tab 202. In this case, the tab 202 on the display screen of the PC 112 or the like can be considered as a switching part or the like for switching the content to be displayed.

Further, in order to display these pieces of information by the PC 112 or the like, the management server 12 of the present example manages at least the information on the printer status, the operation result of the printer 114, the print history in the printer 114, the maintenance history for the printer 114, and the setting/manual in association with the printer 114. Then, the management server 12 transmits printer information including these pieces of information to the PC 112 or the like as necessary. Further, as a result, based on the printer information received from the management server 12, the PC 112 or the like switches and displays these pieces of information according to the user's operation. With this configuration, information necessary for managing the status of the printer 114 can be appropriately presented to the user. Further, as a result, the status of the printer 114 can be efficiently and appropriately managed.

Further, the PC 112 or the like of the present example performs screen display for the printer status as illustrated in FIG. 9. FIG. 9 illustrates an example of a display screen related to the printer status. The printer status displayed by the PC 112 or the like of the present example is information indicating the status of the printer, and indicates at least an ink set name indicating an ink set used in the printer 114, ink information regarding ink used in the printer 114, a drawing range indicating a range in which printing can be executed by the printer 114, a print length indicating a length of output printed by the printer 114, and an amount of waste ink generated in the printer 114. Further, as illustrated in the figure, the PC 112 or the like of the present example displays these pieces of information on one screen by dividing them into the items of the ink information, the drawing range, the print length, and the amount of waste ink based on the printer information in the tab 202 of the printer status (printer status tab) related to the printer details. In this case, the PC 112 or the like displays the ink set name in the item of the ink information in association with the ink information. Further, in the item of the ink information, the PC 112 or the like displays a remaining amount of ink and an expiration date of the ink for each color of ink used in the printer 114 as the ink information. In this case, the PC 112 or the like displays display (% display) indicating a ratio of the remaining amount and display (cc display) directly indicating a liquid amount of the remaining ink as the remaining amount of ink. Further, a date set as an expiration date by which the ink can be appropriately used is displayed as the expiration date. Further, the PC 112 or the like may display information other than these as the ink information. In this case, it is conceivable to display a lot number or the like indicating a production lot in which the ink was produced, and the like as the ink information. Further, the PC 112 or the like can also display progress in printing by the printer 114 as the printer status. With this configuration, time remaining in printing can be measured, and thus the user can perform different work according to end time of printing and prepare for the next printing.

Further, in the item of the drawing range, the PC 112 or the like displays the width and length of the drawing range with respect to the drawing range. In this case, as illustrated as an effective drawing width and an effective drawing length in the figure, it is conceivable to display the effective width and length as a range in which printing can be executed in the printer 114. Further, as illustrated in the figure, the PC 112 or the like in the item of the print length displays the print length (output length) in which output is performed in the print job executed immediately before with respect to the print length. In the item of the amount of waste ink, the PC 112 or the like displays the amount of waste ink generated in the printer 114. Further, in this case, the PC 112 or the like displays the amount of waste ink by display (% display) indicating a ratio to a capacity of a storing unit (for example, a waste ink tank) that stores the waste ink in the printer 114. According to the present example, information useful for managing the status of the printer 114 can be appropriately displayed as the printer status.

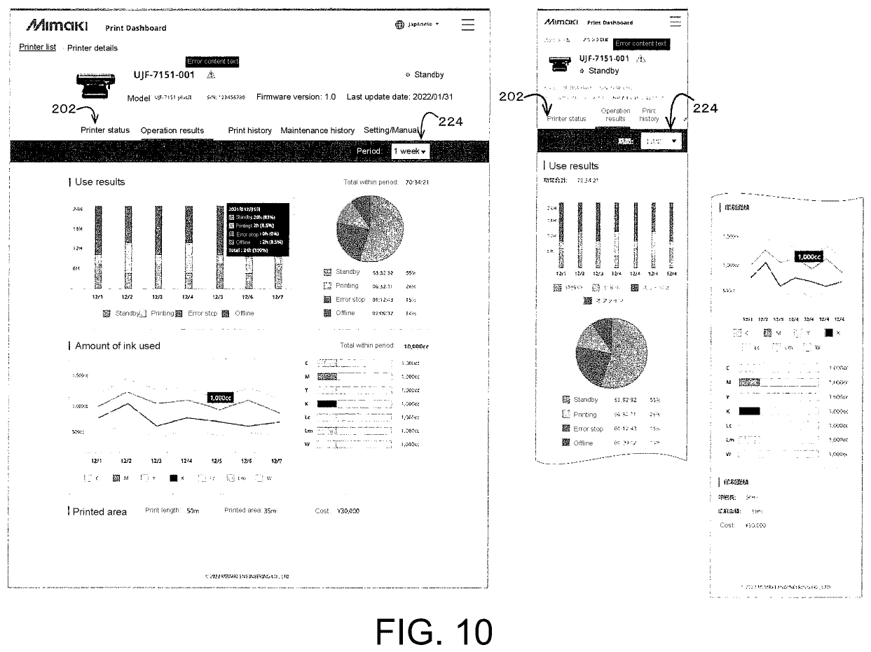

Further, the PC 112 or the like perform screen display for the operation result of the printer 114 as illustrated in FIG. 10. FIG. 10 illustrates an example of a display screen related to the operation result of the printer 114. Based on the printer information, the PC 112 or the like of the present example displays, as the operation result of the printer 114, at least information indicating the aggregation of the operation information indicating the operation status of the printer 114, the aggregation of the amount of ink used in the printer 114, and the aggregation of the printed area, which is area where printing has been performed in the printer 114. Further, as illustrated in the figure, the PC 112 or the like of the present example displays these pieces of information on one screen by dividing them into the items of the use result, the amount of ink used, and the printed area in the tab 202 of the operation result (an operation results tab) regarding the printer details.

In this case, the PC 112 or the like displays the aggregation of the operation information in the item of the use result. Further, as described above, the operation status of the printer 114 can be considered as any one of the status of printing, standby, error stop, and offline. Then, in this case, as illustrated in the figure, the PC 112 or the like displays, as the aggregation of the operation information, the aggregation of the printing period during which the printer 114 has been printing, the standby period indicating a period during which the printer 114 has been on standby, the error stop period during which the printer 114 has been in error stop, and the offline period during which the printer 114 has been offline. The aggregation of these periods can be considered as aggregation of time periods or the like during which the device has been in that operation status, and the like. The aggregation of the printing period can be considered as aggregation of the period during which printing has been executed by the printer 114, and the like. The aggregation of the standby period can be considered as aggregation of the period during which the printer has been in a standby status, and the like. The aggregation of the error stop period can be considered as aggregation of the period during which the printer 114 has been stopped due to an error, and the like. The aggregation of the offline period can be considered as aggregation of the period during which the information of the printer 114 could not be acquired, and the like. With this configuration, the operation status of the printer 114 can be appropriately grasped.

Further, as illustrated in the figure, the PC 112 or the like of the present example displays a bar graph and a pie chart indicating the time periods during which the printer was in each of a plurality of types of status (operation status) of the printer 114 as the aggregation of operation status. With this configuration, it is possible to cause the PC 112 or the like to appropriately perform display that facilitates grasping of the operation status. Further, as a result, the aggregation of operation status of the printer 114 can be appropriately grasped. Further, in this case, the PC 112 or the like directly indicates the time periods for each operation status by the bar graph, and indicates the ratio of the time periods for each operation status by the pie chart.

Further, in the item of the amount of ink used, the PC 112 or the like displays the aggregation of the amount of ink used in the printer 114. Further, the PC 112 or the like of the present example displays a line graph and a bar graph as illustrated in the figure as the aggregation of the amount of ink used. In this case, the PC 112 or the like displays the amount of ink used for each color in time series by the line graph. Further, the amount of ink used for each color over a total period is displayed by the bar graph. Further, in the item of the printed area, the PC 112 or the like displays the aggregation of the printed area in the printer 114. Further, the PC 112 or the like of the present example performs displaying the print length, the printed area, and the cost as the aggregation of the printed area as illustrated in the figure. In this case, the aggregation of the printed area can be considered as a parameter or the like that increases according to the amount of medium consumed. According to the present example, information useful for managing the status of the printer 114 can be appropriately displayed as the operation result of the printer 114.

Further, as illustrated in the figure, the PC 112 or the like of the present example further displays the period setting part 224 on the display screen of the operation result tab. In this case, the period setting part 224 is a part for receiving designation of the aggregation period from the user. In the PC 112 or the like of the present example, by the period setting part 224, receives designation of the aggregation period (display period) from the user who operates the period setting part 224 for the aggregation of operation status of the printer, the aggregation of the amount of ink used, and the aggregation of the printed area. Then, in a case where the period setting part 224 receives the designation of the period from the user, the PC 112 or the like displays the above aggregations according to the designated period. With this configuration, the operation result of the printer 114 can be more appropriately displayed according to the period selected by the user.

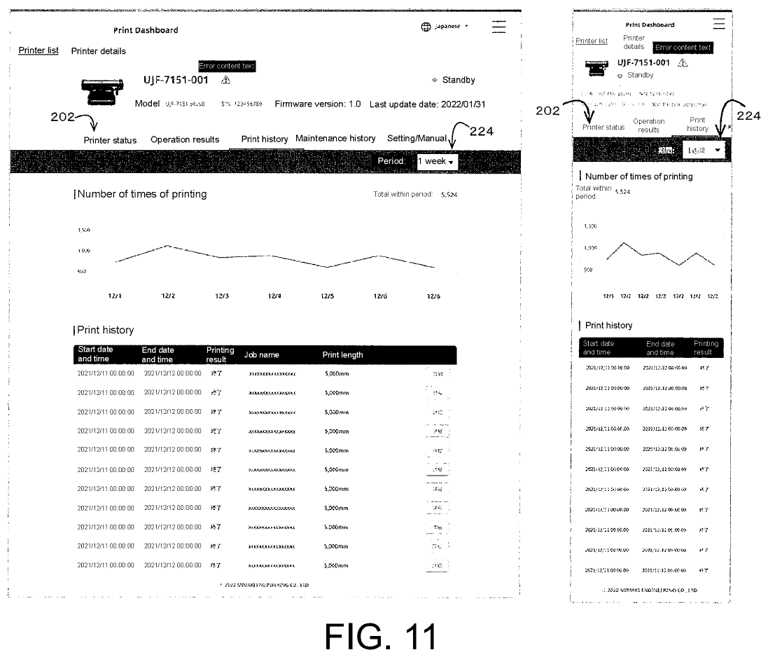

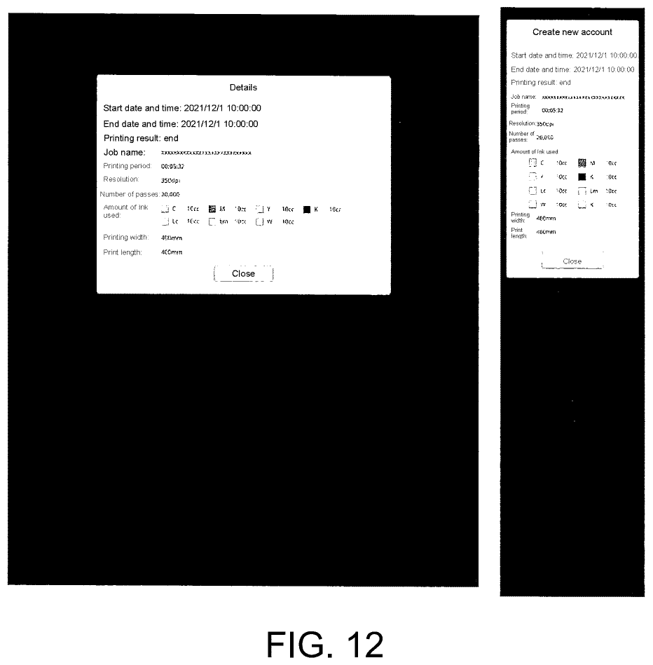

Further, the PC 112 or the like performs screen display for the print history as illustrated in FIGS. 11 and 12. FIGS. 11 and 12 illustrate an example of a display screen related to the print history. The PC 112 or the like of the present example displays, as the print history, information indicating at least a history related to the number of times of printing (print count) and a history of the print job executed in the past based on the printer information. Further, as illustrated in the figure, the PC 112 or the like displays these pieces of information on one screen by dividing them into the items of the number of times of printing and the print history in the tab 202 of the print history (a print history tab) regarding the printer details. In this case, in the item of the number of times of printing, the PC 112 or the like displays a graph indicating a change in the number of times of printing in time series. Further, in this case, as illustrated in the figure, it is conceivable to display a graph indicating the number of times of printing for each day. Further, in the item of the print history, the PC 112 or the like displays information on the print job executed in the past side by side. In this case, as illustrated in the figure, it is conceivable to display start date and time, end date and time, a printing result, a job name, the print length, and the like for each print job. Further, the PC 112 or the like of the present example further displays a button for displaying details of the print job in association with the print job. Then, in a case where this button is pressed by the user, the PC 112 or the like displays more detailed information on the print job by, for example, displaying the screen illustrated in FIG. 12. Further, the PC 112 or the like displays the start date and time, the end date and time, the printing result, the job name, printing time, resolution, the number of passes, the amount of ink used, a printed width, the print length, and the like as more detailed information on the print job, as illustrated in the figure. Further, the amount of ink used for each color is displayed as the amount of ink used. According to the present example, information useful for managing the status of the printer 114 can be appropriately displayed as the print history.

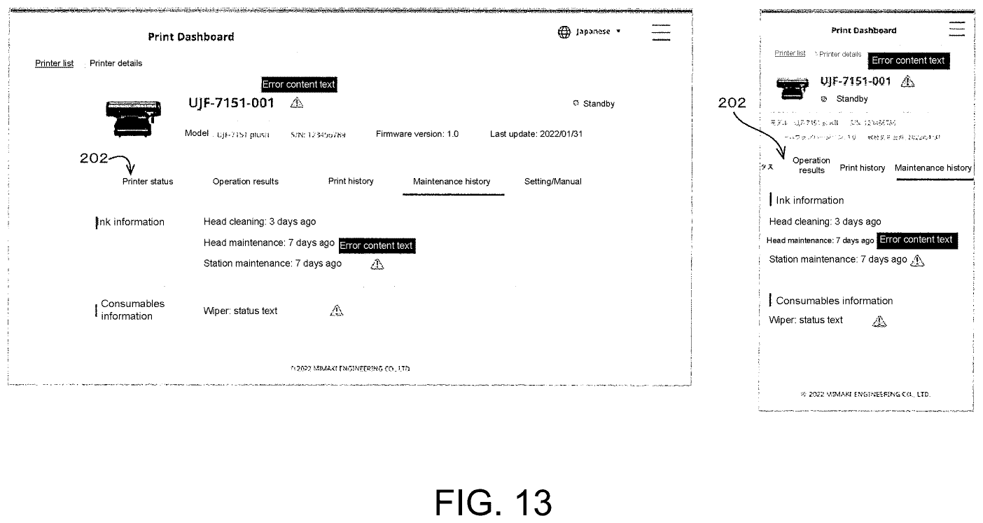

Further, the PC 112 or the like displays performs screen display for the maintenance history as illustrated in FIG. 13. FIG. 13 illustrates an example of a display screen related to the maintenance history. The maintenance history can be considered as information indicating at least the date when the predetermined maintenance was most recently performed on the printer 114. The PC 112 or the like of the present example displays information related to the maintenance history based on the printer information. Further, as illustrated in the figure, the information related to the maintenance history is displayed on one screen by being divided into the items of the ink information and the consumables information in the tab 202 of the maintenance history (a maintenance history tab) related to the printer details.

Here, as described above, it is conceivable to use an inkjet printer as the printer 114 of the present example. Then, in this case, it can be considered that maintenance performed on an inkjet head included in the printer 114 is particularly important as the maintenance performed on the printer 114. Therefore, the PC 112 or the like of the present example displays the maintenance history for at least a part of the maintenance performed in relation to the inkjet head in the item of the ink information. In this case, as illustrated in the figure, the PC 112 or the like displays the date when the predetermined maintenance such as head cleaning, head maintenance, and station maintenance was most recently performed (the last execution date of the maintenance).

Further, the PC 112 or the like of the present example displays information on the status of the consumables used in the printer 114 in the item of the consumables information. In this case, the consumables to be displayed in this item can be considered as replacement parts or the like that are worn due to use of the printer 114. Further, these consumables can also be considered as parts or the like to be replaced as necessary during maintenance or the like of the printer 114. Further, such consumables can also be considered as components or the like constituting a part of the printer 114. The components constituting a part of the printer 114 can be considered as components or the like continuously attached to a predetermined position of the printer 114, instead of being consumed in a printing operation, such as ink and a medium. Further, in FIG. 13, as an example of the consumables, information on a wiper used for maintenance on the inkjet head is displayed. Further, in the item of the consumables information, the PC 112 or the like displays the status of the consumables. In this case, as the status of the consumables, for example, it is conceivable to display the date when the consumable was most recently replaced, the period during which the consumable is used, and the like. Further, it is also conceivable to display a degree of consumption of the consumables as the status of the consumables. According to the present example, information useful for managing the status of the printer 114 can be appropriately displayed as the maintenance history.

Further, in the maintenance history tab, the PC 112 or the like may further display a warning (an alert) or the like related to maintenance or consumables. In this case, for example, it is conceivable to cause the PC 112 or the like to perform at least one of a warning (maintenance execution alert) for prompting execution of the maintenance and a warning (consumables replacement alert) for prompting replacement of consumables used in the printer 114. With this configuration, a warning related to maintenance can be appropriately issued to the user.

In this case, the PC 112 or the like displays whether or not a preset recommended maintenance has been performed. Then, in a case where the recommended maintenance is not performed, it is conceivable to cause the PC 112 or the like to issue a warning for prompting maintenance. With this configuration, it is possible to appropriately notify the user whether or not the necessary maintenance is performed. In this case, it is possible to allow the user to recognize the importance of maintenance by indicating a guide to the necessary maintenance. Further, as a result, it is possible to prevent a trouble from occurring in the printer in advance. Furthermore, it is possible to perform maintenance more definitely by issuing a warning for prompting maintenance. Further, it is conceivable that the PC 112 or the like issues a warning for prompting replacement of the consumables according to a preset replacement timing or the status of the consumables. In this case, the PC 112 or the like may be caused to notify the inventory information of the consumables. With this configuration, information useful for considering replenishment of the consumables can be appropriately presented to the user. Further, in this case, the PC 112 or the like may prompt the user to order the consumables based on the inventory status of the consumables. With this configuration, it is possible to allow the user to more appropriately recognize necessity of replenishing the consumables.

Further, as described above, the PC 112 or the like of the present example is an example of an electronic apparatus that performs display based on the printer information received from the management server 12. Further, in this case, it is also conceivable to perform display by the PC 112 or the like in the external management unit 16, in addition to the PC 112 or the like at the user base 14 where printing has been performed using the printer 114. In this case, the PC 112 or the like at the user base 14 can be considered as an example of the user device. The user device can be considered as an electronic apparatus or the like that displays information to a user who uses the printer 114. Further, the PC 112 or the like in the external management unit 16 can be considered as an example of the maintenance personnel device. The maintenance personnel device can be considered as an electronic apparatus or the like that displays information to a maintenance personnel who provides maintenance service to the printer 114.

Further, in this case, it is conceivable that the maintenance history or the like is displayed on the external management unit 16 to a user who checks the information with the PC 112 or the like, which may be useful in providing maintenance service for the printer 114. In this case, by displaying the maintenance history as described above on the PC 112 or the like used as the maintenance personnel device, it is possible to easily and appropriately grasp whether or not the recommended maintenance has been performed even at a place away from the printer 114 or the like. Further, as a result, it is possible to appropriately notify the maintenance personnel of the status of the printer useful for performing maintenance. Further, in this case, for example, when a problem occurs in the printer 114 having an issue, it is possible to easily and appropriately take a measure based on whether or not the recommended maintenance has been performed. Furthermore, it is also possible for the maintenance personnel to quickly respond to a trouble by grasping the maintenance history. Further, it is also useful to display the maintenance history, such as whether or not the recommended maintenance has been performed, not only on the PC 112 or the like used as the maintenance personnel device, but also on the PC 112 or the like used as the user device. With this configuration, it is possible to appropriately indicate a guide to the necessary maintenance to the user who uses the printer 114 as described above.

Further, although not illustrated, the PC 112 or the like displays information on the setting/manual according to the user's operation on the tab 202. In this case, the PC 112 or the like displays information indicating the settings of the printer 114 or information on the manual of the printer 114 based on the printer information. According to the present example, various information related to the printer 114 can be appropriately displayed on the PC 112 or the like. Further, in the above description, an example of detailed information displayed for one printer 114 has been mainly described with reference to FIGS. 9 to 13. However, the detailed information on the printer 114 is not limited to the information on one printer 114, and information on a plurality of printers 114 may be displayed on the PC 112 or the like. Further, in this case, for example, it is conceivable to cause the PC 112 or the like to display information obtained by performing aggregation for the printers 114 included in the same group, information obtained by performing aggregation for all the printers 114 associated with the same user, and the like with respect to the same or similar items as those illustrated in FIGS. 9 to 13.

As described above, the management server 12 of the present example manages the printer 114 in association with the user of the printer 114. Further, the printers 114 are managed by being divided into groups including one or more printers 114. Then, in a case where the management server 12 manages a plurality of printers 114 associated with the user who operates the PC 112 or the like, the PC 112 or the like may display the information based on the printer information by at least any one of the display manners of the display for each printer, the group display, and the full display regarding the display manner based on the printer information with respect to the same or similar items as those illustrated in FIGS. 9 to 13. In this case, the PC 112 or the like displays the information based on the print information by at least any one of the display manners of the display for each printer, the group display, and the full display according to the user's selection, for example, in a similar manner to the display manner described with reference to FIGS. 6 to 8.

Further, in this case as well, the PC 112 or the like selects one of the batch display and the individual display according to the user's instruction for the display for each printer, the group display, and the full display. Further, as a result, the information based on the printer information is displayed by one of the batch display and the individual display. In this case as well, the display for each printer can be considered as display of information on the individual printers 114. The group display can be considered as display of information on the printers 114 included in any of the groups. The full display can be considered as display of information on all the printers 114 associated with the user. Further, the batch display can be considered as display or the like in which the display for each printer, the group display, and the full display are performed on one screen. The individual display can be considered as display or the like in which any one of the display for each printer, the group display, and the full display is selected and individually displayed. With this configuration, in a case where the management server 12 manages a plurality of printers 114 associated with the user, the display manner based on the printer information can be selected from a plurality of methods. Further, in this case, by selecting one of the batch display and the individual display according to the user's instruction and causing the PC 112 to display the information based on the printer information, the information required by the user can be appropriately displayed on the PC 112 or the like. Further, as a result, the status of the printer 114 can be appropriately grasped.

Further, in a case where the management server 12 manages a plurality of printers 114 associated with the user who operates the PC 112 or the like, the PC 112 or the like may display, on one screen, the aggregation display in which information on the plurality of printers 114 associated with the user is aggregated and displayed and the display for each printer in which information on the individual printers 114 is displayed with respect to the same or similar items as those illustrated in FIGS. 9 to 13. Further, in this case, the PC 112 or the like displays at least one of the group aggregation display and the full aggregation display in the aggregation display according to the user's selection. In this case as well, the group aggregation display can be considered as display or the like in which information on the printers 114 included in the same group is aggregated. Further, the full aggregation display can be considered as display or the like in which information on all the printers 114 associated with the user is aggregated. Further, in this case, the PC 112 or the like performs only one of the group aggregation display and the full aggregation display as the aggregation display in the aggregation display. Further, for example, it is also conceivable to perform both the group aggregation display and the full aggregation display as the aggregation display according to information or the like desired by the user. With this configuration, information required by the user can be appropriately displayed on the PC 112 or the like. Further, as a result, the status of the printer 114 can be more appropriately grasped.

Further, the PC 112 or the like may further display various information, warnings, and the like other than the above. In this case, it is also conceivable to issue a warning regarding continuation of sign-in (a sign-in continuation alert) or the like to the user. As can be understood from the above description and the like, the management server 12 of the present example is a server accessed from the user base 14 and the like, and manages the printer information while identifying the user by user authentication. Further, the management server 12 receives the sign-in of the user by user authentication via the PC 112 or the like. In this case, the sign-in to the management server 12 can be considered as sign-in to a management screen (dashboard) of the management server 12 via a program executed by the PC 112 or the like. Then, in this case, it is conceivable to cause the PC 112 or the like to warn the user that the sign-in is continuing when a preset time period has elapsed after the sign-in of the user. With this configuration, it is possible to appropriately prevent a sign-in status for a long time from continuing without the user noticing. Further, in a case where data is transmitted (uploaded) from the PC 112 or the like to the management server 12 in the background, or the like, the PC 112 or the like may be caused to notify that data is uploading in the background when a certain period has elapsed. Further, it is conceivable to cause the PC 112 or the like to perform these warnings and notifications by a toast notification or the like. With this configuration, warning, notification, and the like can be appropriately issued to the user. Further, in display of specific information included in the various types of printer information, it is also conceivable to filter data of items that are unnecessary by the user in the specific information that the user wants to check. With this configuration, it is possible to make it easier for the user to visually identify the necessary data.

Further, in the above description, for example, using the inkjet printer has been described for the printer 114 used in the printing system 10. However, as the printer 114 used in the printing system 10, a printer other than the inkjet printer may be used. Further, it is also conceivable to use a 3D printer as the printer 114 used in the printing system 10.

### INDUSTRIAL APPLICABILITY

The present invention can be preferably used, for example, in a display method for displaying information on an electronic apparatus.

### REFERENCE SIGNS LIST

10 Printing system
102 Production base
104 Management department
106 Marketing department
108 Support department
112 PC
114 Printer
116 Electronic device
12 Management server
14 User base
16 External management unit
202 Tab
212 Operation information display part
214 Ink usage display part
216 printed area display part
218 Period setting part
222 Display target selection part
224 Period setting part

To the claims:

1. A display method for causing an electronic apparatus to display an information in a printing system that includes a printer, a management server that manages a printer information that is an information indicating a status of the printer, and the electronic apparatus that performs a display based on the printer information acquired from the management server, the display method comprising:
an information transmission step of transmitting the printer information associated with the printer from the management server to the electronic apparatus; and
a display step of causing the electronic apparatus to display an information based on the printer information transmitted from the management server to the electronic apparatus in the information transmission step,
wherein
the management server manages, as the printer information, at least:
an operation information indicating an operation status of the printer;
an ink usage information indicating an amount of ink used in the printer; and
a printed area information indicating a printed area, which is an area where a printing has been performed in the printer, in association with the printer,
wherein
in the information transmission step, at least the operation information, the ink usage information, and the printed area information are transmitted from the management server to the electronic apparatus, and
in the display step, based on the operation information, the ink usage information, and the printed area information, an aggregation of the operation status of the printer, an aggregation of the amount of ink used in the printer, and an aggregation of the printed area where the printing has been performed in the printer are displayed on one screen.

2. The display method as set forth in claim 1, further comprising:
an aggregation period setting step of setting an aggregation period corresponding to an information to be displayed on the electronic apparatus in the display step,
wherein
in the aggregation period setting step, a period during which the aggregation of the operation status is performed, a period during which the aggregation of the amount of ink used is performed, and a period during which the aggregation of the printed area is performed are collectively or individually set according to a user's selection, and
in the display step, the aggregation of the operation status, the aggregation of the amount of ink used, and the aggregation of the printed area are displayed on the electronic apparatus according to the period set in the aggregation period setting step.

3. The display method as set forth in claim 1, wherein
in the display step, the electronic apparatus is caused to display, as the aggregation of the operation status, an aggregation including:
a standby period indicating a period during which the printer has been on standby;
a printing period indicating a period during which printing has been executed by the printer;
an error stop period indicating a period during which the printer has been stopped due to an error; and
an offline period indicating a period during which information of the printer could not be acquired.

4. The display method as set forth in claim 1, wherein
in the display step, as the aggregation of the operation status, a bar graph or a pie chart indicating a time period during which the printer was in each of a plurality of types of status of the printer is displayed on the electronic apparatus.

5. The display method as set forth in claim 1, wherein
in the display step, an operational status of the printer is visualized by causing the electronic apparatus to display the aggregation of the operation status corresponding to the printer.

6. The display method as set forth in claim 1, wherein
in the display step, a bar graph or a line graph is displayed on the electronic apparatus as the aggregation of the amount of ink used.

7. The display method as set forth in claim 1, wherein
the printer performs printing using a plurality of colors of ink, and
in the display step, for the aggregation of the amount of ink used, either or both of the aggregation of the amount of ink used for each color and the aggregation of the amount of ink used in a total amount of ink used obtained by aggregating all the colors of the plurality of colors of ink are displayed on the electronic apparatus according to a user's selection.

8. The display method as set forth in claim 1, wherein
in the display step, a bar graph or a line graph is displayed on the electronic apparatus as the aggregation of the printed area.

9. The display method as set forth in claim 1, wherein
in the display step, the aggregation of the printed area is divided and displayed for each category in a plurality of preset categories.

10. The display method as set forth in claim 1, wherein
in the display step, a plurality of the aggregation of the operation status of the printer, the aggregation of the amount of ink used, and the aggregation of the printed area are displayed in one graph.

11. The display method as set forth in claim 1, wherein
in the display step,
a cursor that moves according to a user's operation, and
a graph showing at least one of the aggregation of the operation status of the printer, the aggregation of the amount of ink used, and the aggregation of the printed area are displayed,
furthermore, in a case where the cursor is positioned on the graph by the user's operation, a numerical value corresponding to a position of the cursor in the graph is displayed.

12. (canceled)

13. (canceled)

14. (canceled)

15. (canceled)

16. A display method for causing an electronic apparatus to display an information in a printing system that includes a printer, a management server that manages a printer information that is an information on the printer, and the electronic apparatus that performs a display based on the printer information acquired from the management server, the display method comprising:
an information transmission step of transmitting the printer information associated with the printer from the management server to the electronic apparatus; and
a display step of causing the electronic apparatus to display an information based on the printer information transmitted from the management server to the electronic apparatus in the information transmission step,
wherein
the management server manages the printer in association with a user of the printer, and manages printers by dividing the printers into groups including one or more printers, and
in a case where the management server manages a plurality of the printers associated with the user, in the display step, with respect to a display manner based on the printer information,
from among a plurality of types of display manners that include:
a display for each printer in which information on the individual printers is displayed;
a group display in which information on the printers included in any of the groups is displayed; and
a full display in which information on all the printers associated with the user is displayed, according to the user's instruction,
one of a batch display and an individual display is selected,
wherein the batch display in which the display for each printer, the group display, and the full display are performed on one screen, and the individual display in which one of the display for each printer, the group display, and the full display is selected and displayed, and
the information based on the printer information is displayed on the electronic apparatus.

17. (canceled)

18. (canceled)

19. (canceled)

20. (canceled)

21. (canceled)

22. (canceled)

23. (canceled)

24. (canceled)

25. (canceled)

26. (canceled)

27. A display method for causing an electronic apparatus to display an information in a printing system that includes a printer, a management server that manages a printer information that is an information on the printer, and the electronic apparatus that performs a display based on the printer information acquired from the management server, the display method comprising:
an information transmission step of transmitting the printer information associated with the printer from the management server to the electronic apparatus; and
a display step of causing the electronic apparatus to display the information based on the printer information transmitted from the management server to the electronic apparatus in the information transmission step,
wherein
the management server manages, as the printer information, at least:
a printer status indicating a status of the printer;
an operation result of the printer;
a print history of the printer; and
a maintenance history for the printer, in association with the printer,
wherein
in the information transmission step, at least the printer status, the operation result, the print history, and the maintenance history are transmitted from the management server to the electronic apparatus, and
in the display step, the printer status, the operation result, the print history, and the maintenance history are switched and displayed on the electronic apparatus according to a user's operation.

28. The display method as set forth in claim 27, wherein
the printer status is an information indicating at least:
an ink set name indicating an ink set to be used in the printer;
an ink information related to ink to be used in the printer;
a drawing range indicating a range in which a printing is capable of being executed by the printer;
a print length indicating a length of an output printed by the printer; and
an amount of waste ink generated in the printer.

29. The display method as set forth in claim 27, wherein
the operation result is an information indicating at least:
an aggregation of an operation information indicating an operation status of the printer,
an aggregation of an amount of ink used in the printer, and
an aggregation of a printed area, which is an area where the printing has been performed in the printer.

30. The display method as set forth in claim 27, wherein
the print history is an information indicating at least a history related to a number of times of the printing and a history of a print job executed in the past.

31. The display method as set forth in claim 27, wherein
the maintenance history is an information indicating at least a date when a predetermined maintenance has been most recently performed on the printer, and
in the display step, the electronic apparatus is caused to perform at least one of a warning for prompting an execution of the maintenance and a warning for prompting a replacement of consumables used in the printer.

32. (canceled)

33. (canceled)

34. (canceled)

35. (canceled)

36. The display method as set forth in claim 27, wherein
the management server receives a sign-in of the user by a user authentication via the electronic apparatus, and
in a case where a preset time period has elapsed after the sign-in of the user, the electronic apparatus is caused to warn the user.

37. The display method as set forth in claim 27, wherein
the management server manages the printer in association with the user of the printer, and manages printers by dividing the printers into groups including one or more printers, and
in a case where the management server manages a plurality of the printers associated with the user, in the display step, regarding a display manner based on the printer information,
from among a plurality of types of display manners that include:
a display for each printer in which information on the individual printers is displayed;
a group display in which information on the printers included in any of the groups is displayed; and
a full display in which information on all the printers associated with the user is displayed, according to the user's instruction,
one of a batch display and an individual display is selected,
wherein the batch display in which the display for each printer, the group display, and the full display are performed on one screen, and
the individual display in which one of the display for each printer, the group display, and the full display is selected and displayed, and
the information based on the printer information is displayed on the electronic apparatus.

38. The display method as set forth in claim 27, wherein
the management server manages the printer in association with the user of the printer, and manages printers by dividing the printers into groups including one or more printers, and
in a case where the management server manages a plurality of the printers associated with the user, in the display step, an aggregation display and a display for each printer are displayed on the electronic apparatus on one screen, wherein
the aggregation display in which information on a plurality of the printers associated with the user is aggregated and displayed, and
the display for each printer in which information on the individual printers is displayed,
wherein
in the aggregation display,
one of a group aggregation display and a full aggregation display is displayed on the electronic apparatus, wherein
the group aggregation display in which information on the printers included in the same group is aggregated, and
the full aggregation display in which information on all the printers associated with the user is aggregated.

39. (canceled)

40. (canceled)

41. (canceled)
